(19) United States
(12) Patent Application Publication
(10) Pub. No.: US 2002/0027869 A1
(43) Pub. Date: Mar. 7, 2002

(54) Optical data recording medium, stamper, and method of manufacture of stamper

(75) Inventors: Seiji Morita, Yokohama (JP); Hiroshi Konishi, Tokyo (JP); Madoka Nishiyama, Yokohama (JP)

Correspondence Address: STAAS & HALSEY LLP, 700 11TH STREET, NW, SUITE 500, WASHINGTON, DC, 20001, US

(73) Assignee: NIKON CORPORATION, TOKYO (JP)

(21) Appl. No.: 09/939,663

(22) Filed: Aug. 28, 2001

(30) Foreign Application Priority Data
Aug. 28, 2000 (JP) 2000-257003
Aug. 30, 2000 (JP) 2000-261337
Dec. 28, 2000 (JP) 2000-399873
Dec. 28, 2000 (JP) 2000-399872

(51) Int. Cl. G11B 7/24

(52) U.S. Cl. 369/275.4

(57) ABSTRACT

In a disk-shaped optical recording medium, in the program region and lead-out region, at least one of the track pitch and linear speed is slower than in the PCA region and PMA region. Because the track pitch and linear speed in the PCA region, PMA region and lead-in region are standard, the lead-in start radius, program start radius, and time from the lead-in start to the program region can be kept within the standard. On the other hand, in the program region, because at least one of the track pitch and linear speed is slower than in the standard case, the recording capacity of the program region can be increased. Accordingly, the optical recording medium can be utilized on standard drives without violating the standards imposed on the disk, and the recording capacity can be increased.

### CROSS-REFERENCE TO RELATED APPLICATIONS

This application is based upon and claims priority of Japanese Patent Applications Nos. 2000-257003 filed Aug. 28, 2000; 2000-261337 filed Aug. 30, 2000; 2000-399873 filed Dec. 28, 2000; and 2000-399872 filed Dec. 28, 2000, the contents being incorporated herein by reference.

### BACKGROUND OF THE INVENTION

1. Field of the Invention

The present invention relates to optical disks, CD, CD-R, CD-RW, DVD, DVD-R, DVD-RW and like optical data recording media, stampers for their manufacture, and a method of manufacture of the stampers.

2. Description of the Related Art

Optical disks, magneto-optic disks and the like optical data recording media have come to be widely used as data recording media and audio data recording media. Recently, CD-R, CD-RW, DVD-R, DVD-RW and the like have also come to be used in addition to optical disks and magneto-optic disks. Data is recorded in these optical data recording devices by forming minute pits or the like marks in the surface of a disk-shaped recording medium, or by changing properties due to the magnetism of a film disposed on the surface of a disk-shaped recording medium.

The optical data recording media include meandering grooves and lands that are disposed alternately. Data is usually written on the grooves. Moreover, an optical detector is used for position detection. In order to perform position control, specifically, tracking, the optical detector is caused to travel along a zone where data has been written in the grooves and lands. Specifically, because the intensity of reflected light differs according to whether a position irradiated by the light is the position of a groove or a land, a position control device receiving a reflected light signal controls the position of the optical detector such that light is irradiated precisely in a position where data is written.

Moreover, among the optical data recording devices, in CD-R, CD-RW and the like, standards referred to as the “Orange Book” are set, according to which there are disposed in sequence, from an inner circumference to an outer circumference of a disk-shaped optical data recording medium (referred to hereinafter as “disk”), a power calibration area (PCA) region, a program memory area (PMA) region, a lead-in region, a program region, and a lead-out region.

The PCA is a region for a recording drive to perform a trial recording, and the PMA is a region to record the memory use state of the optical recording medium. Moreover, the lead-in region is an area in which control data provided by the recording device or recording playback device is recorded while recording data on the optical recording medium or while reading out data from the optical recording medium. The program region is a region that can be used by the user, and is used for the user to write or read data. The lead-out region, disposed outside the program region, is used to return tracking to the origin when the tracking of the optical detector deviates and slips off the program region.

It is desirable to be able to record a lot of data on the same optical recording medium. By making the track pitch of the optical recording medium as narrow as possible, and making the linear speed (m/s) used for recording or playback of data as slow as possible, the recording density of data is increased. Moreover, it is desirable for the program region to be as wide as possible to be able to record a lot of data on the same optical recording medium.

Japanese Laid-Open Patent Publication JP-A-H10-222874 (hereinafter “JP-A-H10-222874”) discloses a technique for making the recording density greater by reducing the track pitch or linear speed in the program region. Generally, the resolving power of the optical detector is set according to the wavelength (λ) of the light used and the numerical aperture (NA) of the optical system. Therefore, by using a shorter wavelength and higher NA (λ=635-685 nm, NA=0.6) than the normally used wavelength and numerical aperture (λ=780 nm, NA=0.45), the resolving power is increased thereby increasing the recording density and, as a result, the recording capacity increases.

However, a disk in which recording is performed with a recording device using such a short wavelength and high NA to produce reduced spot size results in problems in that the disk cannot be read with a playback device using a typical optical detector having the normally used λ=780 nm, NA=0.45. In particular, there is no interchangeability with other recording devices used in the prior art, and a dedicated playback device has to be used.

Furthermore, because the data of the lead-in region is also not read out, it becomes impossible to recognize the type of disk. By making the track pitch or recording linear density of the lead-in region of the disk disclosed in JP-A-H10-222874 the same as in other prior art optical data recording media, it is possible to recognize the type of disk when using a typical prior art playback device. However, even proceeding in this manner does not change the fact that data written in the program region is not read out.

Furthermore, JP-A-H10-222874 discloses that the track pitch or recording linear density is the same in the PCA region, PMA region, program region, and lead-out region, and that the track pitch is changed only in the lead-in region. Therefore, because the PCA region is a region for a trial recording by the recording drive, and the PMA region is a region to record the memory utilization state of the optical recording medium, the JP-A-H10-222874 device is based on the concept that the recording and playback have to be performed under the same conditions as the program region.

As mentioned above, the mark made by the recording device on the disk is small if a recording device having pickup is used, which comprises an optical system with a high numerical aperture (NA) and a light source emitted short wavelength. Therefore, high density recording on the disk can be obtained. However, a problem exists with the prior art recording and playback device which cannot read the mark on the disk if only a small mark is recorded on the disk.

The optical detector in recording and playback devices normally moves substantially from a start position of the lead-in region of the optical recording medium and, performing focusing, discriminates the track of the optical recording medium. However, when the respective track pitches of the lead-in region, PCA region, and PMA region are narrow, focusing of the optical detector is ineffective, and the optical recording medium is not recognized by the optical detector.

Furthermore, the device disclosed in JP-A-H10-222874 also suffers from the problems described above. For example, when the optical recording medium is installed in a recording and playback device, the optical detector is initially not positioned in the lead-in region. When the optical detector is positioned in the PCA region or PMA region, the optical recording medium cannot be recognized for the above-described reasons when the track pitch is narrow or linear speed is slow.

### SUMMARY OF THE INVENTION

It is an object of the present invention to provide an optical recording medium having interchangeability, a stamper for manufacture of the optical recording medium, and a method of manufacturing of the stamper.

It is another object of the present invention to provide an optical recording medium that manifests maximum performance while using a prior art recording device and playback device, and to provide an optical recording medium with increased recording capacity which can be recognized by the prior art recording devices or playback devices.

It is another aspect of the present invention to provide an optical recording medium having increased recording capacity and a linear speed that is very much slower than that of the conventional optical recording media, and that can be recognized in recording and playback devices.

It is another object of the present invention to provide necessary solution for an optical data recording medium, in order to be able to stably perform reliable optical writing to an optical data recording medium, even if an increase of the recording capacity of the program region is brought about.

A first embodiment of the present invention comprises a disk-shaped optical recording medium that performs recording and playback of data by tracking of a light beam along a meandering groove or land, and having in sequence from an inner circumference to an outer circumference a PCA region, a PMA region, a lead-in region, a program region, and a lead-out region, wherein a track pitch of the program region is narrower than respective track pitches of the PCA region, PMA region, and lead-in region.

In accordance with the first embodiment of present invention, the recording capacity of the optical recording medium is increased by making the respective track pitches of the program region more narrow than the respective track pitches of the PCA region, PMA region and lead-in region. In order to easily recognize the optical recording medium, the respective track pitches of the PCA region, PMA region, and lead-in region are wide. The track pitch in accordance with the first embodiment is such that a tracking error equal to or greater than a permissible value does not arise when using a prior art recording device or playback device. The respective track pitches of the PCA region, PMA region and lead-in region are wide because the optical detector is initially in a place where it focuses, and because recognition of the optical recording medium is difficult when focusing is not easily performed.

Moreover, trial recordings are made in the PCA region and the memory utilization state of the optical recording medium is recorded in the PMA region. In accordance with the present invention, because the respective track pitches of the PCA and PMA regions are wide, tracking is reliable, there is sufficient margin for reading and writing, and calibration can be reliably performed.

Furthermore, because the lead-in start region and the start region of the program region of the optical recording medium of the present invention are set according to the standard, it is preferable for the track pitch to agree with the standard. Furthermore, even if the lead-in region start time is also the manufacturer's recognition code (M-code), and even if it is also the code (T-code) showing the recording method (write strategy), the manufacturer cannot in fact alter it. Furthermore, from the lead-in region start time to the program region beginning time is also set by the standard. Accordingly, there is a risk that the disk will become off-standard when the track pitch of the lead-in region is altered. From this aspect, it is preferable not to unnecessarily narrow the track pitch in the lead-in region.

According to the present inventors' experience, the respective track pitches of the PCA region, PMA region, and lead-in region are preferably 1.3 μm or more if a recording or playback device having a one beam tracking method is used. In this case, with the lead-in region start position at least placed within tolerances of the standard, use becomes possible with most recording and playback devices.

In the above-described manner, in accordance with the present invention, while using a prior art recording device and playback device, their performance can be manifested to the maximum. Moreover, recognition by the recording and playback device becomes possible. In addition, the optical recording medium can have an increased recording capacity.

Moreover, in accordance with embodiments of the present invention, because the respective track pitches of the PCA region positioned in the inner circumferential portion, the PMA region, and the lead-in region are correspondingly wide in comparison with that of the program region, the polycarbonate and the like plastic resin at the time of injection molding is easily injected into and easily enters the meandering groove pattern of the stamper surface. Consequently, transfer is reliably performed because the resin is injected from the inner circumferential portion. Furthermore, in accordance with the present invention, the mold release is particularly good. As a result of the good mold release, it is difficult for clouding to arise when peeling off the internal circumferential portion, the inner circumferential hole can be cleanly processed, and a substrate with small eccentricity can be manufactured.

In accordance with embodiments of the present invention, it is preferable for production of the disks for the respective track pitches of the program region and the lead-out region to be the same. However, the track pitch of the program region and lead-out region do not have to be the same. For example, the track pitch of the lead-out region may be wider than or more narrow than the track pitch of the program region. In accordance with a further preferred embodiment of the present invention for high density recording, the track pitch of the lead-out region is more narrow than the track pitch of the program region.

Because data recording is not performed in the lead-out region, there is no problem if a tracking error arises to some degree. Therefore, in accordance with the present invention, the track pitch of the lead-out region is narrower than the track pitch for stably reading and writing. As described hereinabove, the recording time of the lead-out region is set at 1 minute and 30 seconds or more. But, the start region of the lead-out region is not determined. Therefore, by narrowing the track pitch, the area occupied by the lead-out region on the disk can be made small, and the region that has not already been used for the lead-out region can be used as a program region. Therefore, the recording capacity can be increased.

In accordance with a second embodiment of the present invention, a disk-shaped optical information medium comprising in a direction from an inner circumference to an outer circumference, at least a lead-in region, a program region and a lead-out region, wherein the track pitch of the lead-out region is narrower than the respective track pitches of any other regions.

In accordance with the second embodiment of the present invention, only the track pitch of the lead-out region is narrowed. The track pitch of the lead-out region is narrowed, and the results of narrowing the track pitch of the lead-out region are the same as described above with respect to the first embodiment of the invention.

In accordance with the first and second embodiments of the present invention, it is preferable for the track pitch to change gradually in a transition region in which the track pitch changes. By changing the track pitch gradually in a transition region, large external disturbances do not suddenly enter the tracking control system in the transition region, and tracking is accurately performed, The region in which the track pitch changes, for example, may cause a change extending in the lead-in region and the program region, or may cause a change at the front of the program region. Furthermore, in accordance with the embodiments of the present invention, “gradually” may mean a rate of change of a degree that tracking can follow with sufficient stability.

The change of track pitch is preferably made to end in the lead-in region by making the track pitch of the program region narrower than the respective track pitches of the PCA region, PMA region, and lead-in region, and gradually changing the track pitch in a terminal portion of the lead-in region.

Because the change of track pitch between the lead-in region and the program region ends within the lead-in region, the track pitch does not change in the program region, and stabilized writing and reading are possible.

Moreover, the linear speed is preferably the same in the PCA region and the program region. Because test recordings are made in the PCA region and, because the PCA region is a region which performs calibration while writing in the program region, writing conditions of the linear speed are preferably as far as possible the same as in the program region. In accordance with the present invention, because the linear speed is the same in the PCA region and the program region, the size of marks recorded in both regions can be the same, and because these regions can be written and read out under the same conditions, calibration can be accurately performed.

In accordance with a third embodiment of the present invention, recording and playback of a disk-shaped optical recording medium are performed with a light beam tracked along a meandering groove or land, the disk-shaped optical recording medium composing, in sequence in the direction from an inner circumference to an outer circumference, a PCA region, a PMA region, a lead-in region, a program region, and a lead-out region, wherein the linear speed of the program region is slower than the linear speed of the PCA region, PMA region, and lead-in region.

In accordance with preferred embodiments of the present invention, the linear speed of the lead-out region of the optical recording medium is slower than the linear speed of the program region.

Objects and advantages of the present invention are achieved in accordance with a fourth embodiment of the present invention with a disk-shaped optical information medium comprising in a direction from an inner circumference to an outer circumference, at least a lead-in region, a program region and a lead-out region, wherein the linear speed of the lead-out region is slower than the respective linear speed of any other regions.

In accordance with the third and fourth embodiments of the present invention, the linear speed preferably changes gradually in a transition region, in which the linear speed changes.

Moreover, by making the linear speed of the program region slower than the track pitch of the PCA region, PMA region and lead-In region, the linear speed gradually changes at a terminal portion of the lead-in region, and the change of linear speed preferably ends within the lead-in region.

The third and fourth embodiments of the invention differ in that only the linear speed changes, in contrast to the change of track pitch in the first and second embodiments of the invention. Therefore, the third and fourth embodiments have operative effects similar to the first and second embodiments. Furthermore, for the manufacture of disks, its preferable for the linear speed of the program region and the lead-out region to be the same. However, the linear speed of the program region and the lead-out region are not necessarily the same. For example, the linear speed of the lead-out region may be the same as that of the PCA region, PMA region, and lead-in region.

Furthermore, further advantageous effects can be brought about by a combination of either of the first and second embodiments of the invention and either of the third and fourth invention embodiments. As the method of combination, those described as preferred modes can be optionally combined with their counterparts.

In accordance with the first through fourth embodiments of the invention, the track pitch of the program region is preferably between 1.2 μm and 1.3 μm.

In a prior art recording device or playback device including an optical detector having a wavelength 780 nm, NA=0.45, the standard track pitch is 1.5 μm-1.7 μm. Furthermore, the condition under which the prior art optical detector can track occurs when the peak-to-peak value of a signal (push-pull signal) obtained while the optical detector is passing across a track is greater than a predetermined proportion of the magnitude of the signal obtained from a mirror surface without grooves.

Incidentally, the effect of performing recording or playback by a prior art recording device or playback device is, to the inventors' knowledge, that a sufficient magnitude of push-pull signal is obtained when the track pitch is 1.1 μm or more. Accordingly, tracking becomes possible if the track pitch is 1.1 μm or more. Furthermore, a track pitch of 1.15 μm or more is preferred.

However, in accordance with the present invention, so that the productivity is the same for the optical recording medium as for that of the prior art, a track pitch of 1.2 μm is preferably used.

Conventionally, in CD-R, DVD-R, CD-RW and DVD-RW, a colorant layer or phase change layer is formed as a film on a plastic resin mold corresponding to the shapes of lands and grooves in the plastic resin. Furthermore, the necessary reflective layer and the like are formed as a film. The plastic substrate is molded by an injection molding method using a molding die having the reverse configuration of the form of the plastic substrate. The time required to transfer the shape of the molding die to the plastic resin is six (6) seconds in the case of the usual track pitch.

Accordingly, the present inventors found the minimum track pitch which could be transferred within the time required to transfer the shape of the molding die to the plastic resin. Specifically, the present inventors determined that the standard molding time of six (6) seconds was serviceable for a track pitch of 1.2 μm or more. Accordingly, because the productivity becomes the same as for the prior art CD or CD-R/RW, it becomes possible to produce optical recording media of increased recording capacity under conditions in which a high productivity is maintained.

Moreover, if the track pitch of the program region is less than 1.5 μm, an increase in density becomes possible. Nevertheless, in accordance with the present invention, in order to obtain complete interchangeability such that in actuality tracking is also possible with application of a three-spot tracking method, the upper limiting value of track pitch is made less than 1.3 μm. With a track pitch between 1.3 μm and 1.5 μm, a subspot detects tracking errors, but because of a large effect received from pits formed in adjacent tracks, the subspot was set at this value such that it did not read the center of the neighboring track. Furthermore, because most are at present of the one beam type, lack of conformity with this upper limit is not of importance.

Moreover, when the track pitch is made between 1.2 μm and 1.3 μm, the width of the grooves or lands of the program region on which the data is recording or recorded is preferably between 300 nm and 550 nm.

In the case of a track pitch between 1.2 μm and 1.3 μm, by setting the width of the grooves or lands of the program region in the above-described range, an optical recording medium is obtained in which crosstalk is reduced and also the recording capacity is increased. Furthermore, if the recording or recorded width is 550 nm or less, crosstalk is reduced, but at a width smaller than 300 nm, the pits become small and become unresolved at a wavelength λ=780 nm and numerical aperture NA=0.45. Accordingly, the track pitch is preferably between 300 nm and 550 nm.

Moreover, when the track pitch is between 1.2 μm and 1.3 μm, the laser power used on the optical recording medium is preferably 4.9-6.5 mW.

Narrowing the track pitch in this manner, and/or the width of recording or recorded grooves or lands, in the case that one is narrowed compared with the other, when the laser power when writing (laser power at single speed) is usually about 7.2 mW, pits also become formed in the unrecorded land or groove, and the tendency is for the block error rate to increase. Consequently, it was determined that for a laser power between 4.9 mW and 6.5 mW, and for a program region having the track pitch narrowed, good pit formation becomes possible only toward the recording side.

Moreover, when the track pitch is between 1.2 μm and 1.3 μm, it is preferable to make the amount of eccentricity of the grooves or lands of the optical recording medium 30 μm or less.

It has been determined that when narrowing the track pitch and also experimentally finding the eccentricity at which tracking becomes easy, there are no apparent problems when the amount of eccentricity of the lands or grooves is set at 30 μm or less.

In the first through fourth embodiments, it is preferable to make the linear speed of the program region 1.0 m/s or more.

The minimum linear speed was found at which the minimum mark can be resolved in a prior art recording device or playback device with a wavelength of 780 nm and NA=0.45 and it was determined that resolution is possible at a linear speed of 0.90 m/s or more. Furthermore, according to the present invention, with a degree of modulation of a 3 T mark, or a degree of, modulation of an 11 T mark, the sufficient minimum linear speed was found to obtain a sufficient value in the recording or playback devices considered. It was determined that if the linear speed is 1.0 m/s or more, it is possible to playback a stable signal from optical recording media when reading out or writing.

In the first through fourth embodiments, among the grooves and lands, the width when used for data recording is preferably more narrow than from the width on the side where data is not recorded.

When the track pitch narrows, the tendency is for crosstalk to increase. Nevertheless, even if the track pitch is narrowed among the grooves or lands of the program region, by making the width of recording or recorded side narrow, it is possible to reduce crosstalk. This is because, within the area irradiated by the light spot irradiated from the optical detector, the proportion of the irradiated area of the recording grooves or lands of adjacent tracks can be made narrow. Accordingly, the effect of pits formed in adjacent tracks decreases, and crosstalk is reduced. Moreover, in the case that the present invention is applied where colorant is formed in the recording layer, such as in the CD-R type, it is more preferable to make the width of the recording or recorded side narrow because the degree of signal modulation obtained from the pits tends to increase.

In the first through fourth embodiments, the diameter of the disk-shaped optical recording medium is preferably 80 mm and the recording time is preferably over 30-40 minutes,

In the case where that the diameter of the optical recording medium is 80 mm, when the program region is formed such that the recordable time as CD digital audio is 30-40 minutes, as shown in conjunction with a later embodiment, its utilization value increases and it is possible to use the optical recording medium as recording media of a small size camera or audio recorder.

Furthermore, in the case of an optical recording medium which can record 30 minutes of digital audio, in the ISO19660 Model format, which is a standard for CDs for digital recording, 265 MB of data can be recorded. According to the present invention, by limiting the recording time to less than 30 minutes, in an 80 mm disk, six (6) compositions can be accurately recorded.

Moreover, when the recording time exceeds 40 minutes, in an 8 cm optical recording medium, the track pitch or linear speed of the program area becomes too narrow, tracking cannot be performed and the pits do not obtain a sufficient degree of modulation, jitter becomes large, and recording becomes impossible.

According to the fifth embodiment, a stamper is provided which has convex portions corresponding to the concave portions of an optical recording medium, and concave portions corresponding to the convex portions of the optical recording media.

According to this embodiment, the optical recording media of any of the first through fourth embodiments can be manufactured efficiently.

Further, the amount of eccentricity of the concave portions or convex portions formed in the stamper is 10 μm or less.

By making the amount of eccentricity of the concave portions or convex portions of the stamper 10 μm or less, the amount of eccentricity of the tracks of the optical recording media molded with this stamper easily becomes 30 μm or less. Accordingly, with the optical recording media manufactured with this stamper, tracking becomes easy, as mentioned above, even if the track pitch is narrowed.

According to the sixth embodiment, a method of manufacturing a stamper is characterized by providing a first molding die made of metal, molding a second molding die made of resin from the first molding die, and molding a stamper made of metal, which is a third molding die, from the second molding die.

In the present invention, firstly, by electroplating methods or metallic film forming methods and the like, a first molding die is manufactured which is a stamper which can be utilized to manufacture the optical recording media of the first through fourth embodiments. The first molding die is not used directly for manufacturing the optical recording media, but rather, by taking an impression by pressing a resin against the first molding die, a second molding die, which is made of resin and reverses the concave and convex of the first molding die, is made.

Thereafter, using the second molding die, a stamper made of metal is molded using a method similar to that used in manufacturing the first molding die. In this manner, the stamper, which is the first molding die, is not directly used for manufacturing optical recording media, but rather manufactures plural second molding dies. The actual stampers are made from the plural second molding dies. Because the third molding dies are stampers made of metal, even though lithographic processes are not performed plural times, plural stampers can be manufactured by a simple process.

As described hereinabove, the optical recording medium according to the present invention, while using recording and playback devices of the prior art, can cause the optical recording medium to manifest maximum efficiency, and also, without differing from the standards imposed on the disks, can provide an optical recording medium with an increased recording capacity. Consequently, the recording and playback devices of the prior art can be used. Further it is possible to use an optical recording medium with a large recording capacity. According to the seventh embodiment, a disk-shaped optical information medium has at least a lead-in region, a program region and a lead-out region, and the track pitch of the lead-in region is smaller than the track pitch of any other regions.

Moreover, the stamper according to the present invention can be used to efficiently manufacture optical recording media according to the present invention.

The method of manufacturing of stampers according to the present invention, even without the use of lithographic processes plural times, can be used to manufacture plural stampers by a simple process.

A seventh embodiment of present invention comprises an optical recoding medium that performs recording and playback of data by tracking of a light beam along a meandering groove or land, and having sequence from an inner circumference to an outer circumference a PCA region, a PMA region, a lead-in region, a program region, and a lead-out region, wherein at least one of either a PCA region or a PMA region, the track pitch or linear speed is greater than in the other region[s].

In this manner, according to the seventh embodiment of the present invention, writing and reading to/from the PCA region and PMA region are easily performed, making the track pitch or linear speed large, as regards the PCA region and PMA region in which important data was recorded at the time of optical writing.

In particular, the PCA region, as aforementioned, is a region which performs power calibration of laser power while writing to the optical data recording medium. Because of this, trial writing to the PCA region in order to accurately set the laser power with respect to the optical data recording medium, it is necessary to find as accurately as possible the state of a mark which was formed by the trial writing. The case that an optical pickup was used whose optical characteristics were not very good, is a case in which a more suitable result is obtained than by adopting the invention described at the beginning “linear speed of the PCA region and program region made the same”. In this kind of recording device, an optical data recording medium is preferably used in which the PCA region is larger than other regions, and also the recording density of the program region is increased.

On the other hand, in the PMA region, also as aforementioned, the result is also recorded for the power calibration performed while writing for the first time on the program region used. Accordingly, in addition to accurately reading out a record written in the PMA region, it is necessary to add data to the optical data recording medium. It is therefore preferable to make the track pitch or linear writing speed of the PMA region greater than that of other regions, such that reading from the PMA region becomes possible, and moreover so as to be able to accurately record to the optical data recording medium even while writing on the optical data recording medium.

Furthermore, by making both the PCA region and the PMA region larger than other regions, a synergistic effect can be obtained.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a schematic diagram of the physical format of an optical recording medium according to a first embodiment of the present invention.

FIGS. 2(A) through 2(E) are diagrams showing the distribution of track pitch or linear speed in locations and respective regions of recording region(s) in a CD-R type optical recording medium according to the present invention.

FIG. 3 is a schematic diagram of the physical format of an optical recording medium according to the second embodiment of the present invention.

FIG. 4 is a schematic diagram of the physical format of an optical recording medium according to the third embodiment of the present invention.

FIGS. 5(A) and 5(B) show the distribution of track pitch or linear speed in locations and respective regions of recording region(s) in a CD-R type optical recording medium according to a preferred embodiment of the present invention.

FIG. 6 is a schematic diagram of the physical format of an optical recording medium according to the fourth embodiment of the present invention.

FIGS. 7(A) through 7(E) show the distribution of track pitch or linear speed in locations and respective regions of recording region(s) in a CD-R type optical recording medium according to the present invention.

FIG. 8 is a schematic diagram of the physical format of an optical recording medium according to the fifth embodiment of the present invention.

FIG. 9 is a schematic diagram of the physical format of an optical recording medium according to the sixth embodiment of the present invention.

FIGS. 10(A) through 10(B) show the distribution of track pitch or linear speed in locations and respective regions of recording region(s) in a CD-R type optical recording medium according to a preferred embodiment of the present invention.

FIG. 11 is a diagram showing the manufacturing method of a stamper which is one according to the present invention.

### DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

The content of the present invention is described in detail hereinbelow, based on embodiments of the invention and examples thereof. Furthermore, in the following description, the recording and playback devices are described in which a wavelength of 780 nm and a numerical aperture of 0.45 are used, which are those most frequently used at present. In the present invention, except where limited in the claims, not only are these recording and playback devices used, but also recording and playback devices with different wavelengths and numerical apertures, and accordingly different resolving power, can be used. Further, use is also possible in cases in which standards could be associated with the methods of such recording and playback devices.

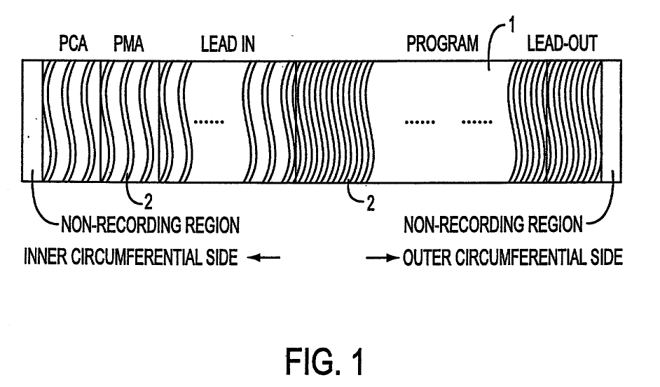

FIG. 1 is a schematic diagram of the physical format of an optical recording medium, represented by CD-R and CD-RW, according to an embodiment of the present invention. The inner circumferential side of the optical recording medium is shown at the left-hand side of FIG. 1 and the outer circumferential side of the optical recording medium is shown at the right-hand side of FIG. 1. The optical recording medium 1 comprises, extending from the inner circumferential side to the outer circumferential side, a non-recording region, a PCA region, a PMA region, a lead-in region, a program region and a lead-out region.

The PCA region is a region for a recording drive to perform a trial recording and calibrate optical power when the optical recording medium is written. The PMA region is a region to record use states of the program region. The lead-in region is a region for memorized contents information recorded in the program region. The contents information are, for example, Table of Contents recorded in the program region and additional data which concern the sector header and so on, which need to control the recording devices or recording playback devices. The program region is a region in which contents stored by user are memorized. The lead-out region is used to return tracking to the origin when the tracking of the optical detector deviates and slips off the program.

A wobbled pre-groove 2 is formed in the optical recording medium 1. This pre-groove 2 is wobbled in a meandering form based on a standard signal having a predetermined frequency and pre-format data in a composite signal (ATIP signal). In the recording device which writes the data on the optical recording medium, recording and playback are performed based on the obtained pre-format data, demodulating two reflected light amounts from this pre-groove.

Furthermore, the pre-groove 2, according to the present invention, is FM modulated with a carrier frequency of 22.05 kHz. Moreover, this pre-groove 2 is formed continuously across the PCA region, PMA region, lead-in region, program region, and lead-out region of the CD-R or CD-RW.

When recording, initially, the optical detector of the recording and playback device moves adjacent to the start position of the lead-in region, which is in the inside region of the optical recording medium 1, and the optical recording medium 1 rotates at a predetermined rotation speed. Thereupon the optical detector moves to the start position of the lead-in region from the preformat region which is read out,

Next, demodulating the pre-groove of the lead-in region, the maximum possible recording time, the recommended power of the writing light, and the disk application code are read out. Then, the PCA region is read and- the power of the writing light is calibrated so as to become optimum. Moreover, before and after the power calibration, the PMA region is read and at a subsequent time the necessary address data is read out.

Moreover, when the pre-groove is demodulated, at least where the optical detector is initially positioned, focusing has to be effected. Accordingly, according to the first embodiment of the present invention, the entire track pitch of the PCA region and of the PMA region, inside from the lead-in region, is made wider than in the program region. In this manner, focusing the optical detector is easily possible. Furthermore, for the program region in which data is recorded, by making the track pitch small, the recording capacity increases.

Furthermore, according to the first embodiment of the present invention, the following points are taken into account.

In the standards for CD-R and CD-RW, the length of the PCA region, 22 seconds or about 40 frames, and the length of the PMA region, 13 seconds or about 25 frames, are set by the standard. Maintaining these lengths, the CD-R and CD-RW according to this embodiment are formed such that the lead-in start radius equals the standard.

In addition, the start radius of the lead-in region and the program region are set at a predetermined position, as well as the lead-in region start time, and the manufacturer cannot in fact optionally alter the manufacturers recognition code (M-code), or the code (T-code) showing the recording method. Furthermore, the time from the lead-in region start time to the program region start time is also set by the standard. Then, the size of the lead-out region is set at 1 minute 30 seconds or more in equivalent recording time.

So as to sufficiently satisfy these standards, the track pitch of each of the PCA region, PMA region and lead-in region, is made similar to the prior art. Moreover, the linear speed is also preferably approximately 1.2 m/s. In this manner, there is sufficient interchangeability with the recording and playback devices from the prior art.

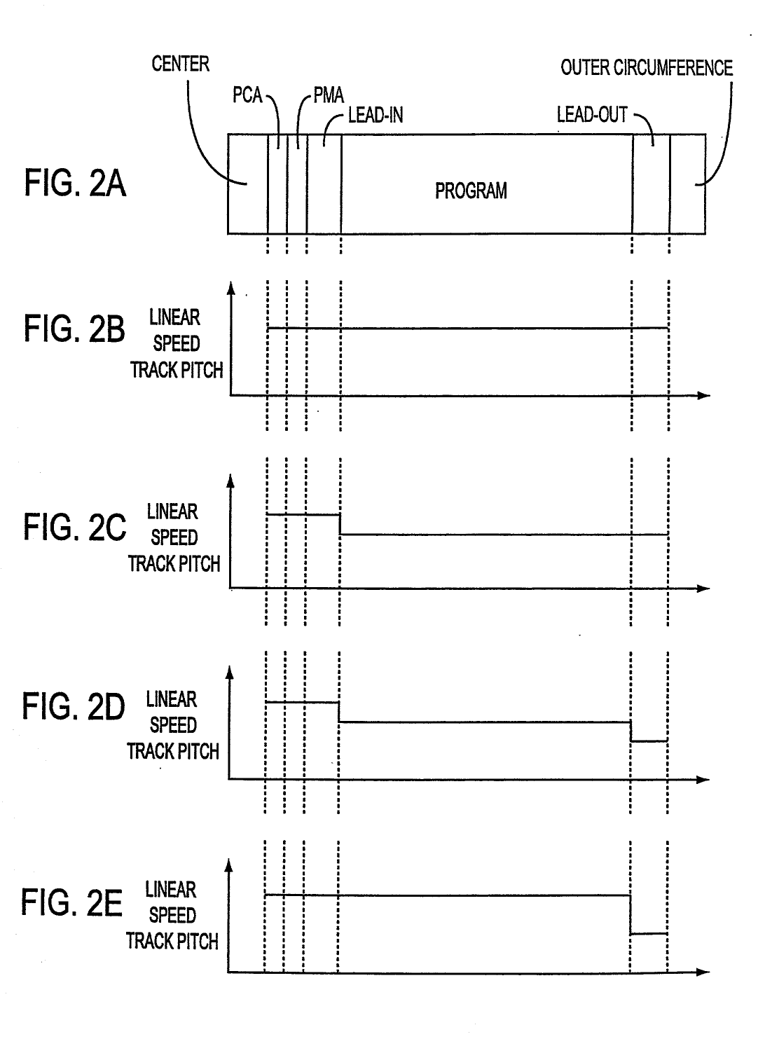

According to first embodiment, the location of the recording region and the track pitch in the respective regions are as shown in FIG. 2(C). FIG. 2(A) shows the location of the recording region of the optical recording medium, from the center there are in sequence: a non-recording region having no groove, the PCA region, PMA region, lead-in region, program region, and lead-out region, and a non-recording region having no groove.

FIGS. 2(A)-2(E) are diagrams showing the distribution of track pitch or linear speed corresponding to each region, FIG. 2(B) corresponds to a prior art CD-R and the like optical recording medium in which; the track pitch and linear speed become constant in the PCA region, PMA region, lead-in region, program region, and lead-out region.

FIG. 2(C) corresponds to a CD-R and the like optical recording medium of the first embodiment of the present invention where in the PCA region, PMA region, and lead-in region, the track pitch is wider than in the program region so that data recorded in these regions to be accurately written and read out.

In contrast, in the program region and lead-out region, the track pitch is more narrow than in the PCA region, PMA region, and lead-in region. In this manner, the recording density of the program region is increased.

Furthermore, if the track pitch is wider than the minimum necessary track pitch of 1.1 μm in the program region, a push-pull signal for tracking control is also obtained in the recording and playback devices of the prior art. Furthermore, preferably if the track pitch is 1.15 μm or more, it has a margin, and a push-pull signal of sufficient magnitude is obtained.

However, because productivity in optical recording medium manufacturing falls when the track pitch is made too narrow, it is preferably set at 1.2 μm or more in the first embodiment of the present invention.

A stamper having lands and grooves of corresponding shape is usually used to manufacture CD-R, DVD-R, CD-RW and DVD-RW. This stamper is a metal die in order to form the shape of lands and grooves in a plastic substrate. The plastic substrate is molded by an injection molding method using this stamper. A film having a colorant layer or phase change layer, and a necessary reflecting film and the like, are formed as films on the plastic substrate, which is molded to form the manufactured optical recording medium.

When molding this plastic substrate, the plastic resin sufficiently penetrates into the concave-convex surface. Then, a cooling and solidification time is necessary. This time is 6 seconds for the prior art optical recording media. Then, to manufacture the optical recording medium, other processes are set simultaneously at this time. In this manner, the optical recording media of the prior art CD-R and the like are manufactured at a low cost.

To maintain productivity in the first embodiment of the present invention, time might be saved in the molding process of the plastic substrate. Furthermore, increasing the die temperature, or increasing the mold closing force are possible methods of shortening the time for sufficient penetration into the concave/convex surface of the stamper. However, according to the former method, the time for cooling increases. Moreover, according to the latter method, the mold closing device itself has to be changed, incurring an increase in cost.

Accordingly, it was discovered that, in the molding conditions of the plastic substrate, for 6 seconds to be possible, a track pitch of 1.2 μm or more was preferable.

Moreover, if the upper limit of the track pitch for the program region is less than 1.5 μm, higher density becomes possible. Furthermore, to obtain complete interchangeability in the present invention, the upper limit of track pitch was made 1.3 μm. Several types of recording or playback devices have used the three beam tracking method for tracking the track of the medium. It is known that a recording or playback device using the three beam tracking method experiences a tracking error when it is recording or playing back a medium which has a track pitch between 1.3 μm and 1.5 μm. With a track pitch greater than this value, a subspot detects tracking errors, but because of a resulting large effect of marks formed in a neighboring track, the subspot was set at this value such that it did not read the center of the neighboring track. Furthermore, with the object that the subspot is at the periphery of an adjacent track, the track pitches of a track and an adjacent track are equal, and no problems arise in tracking.

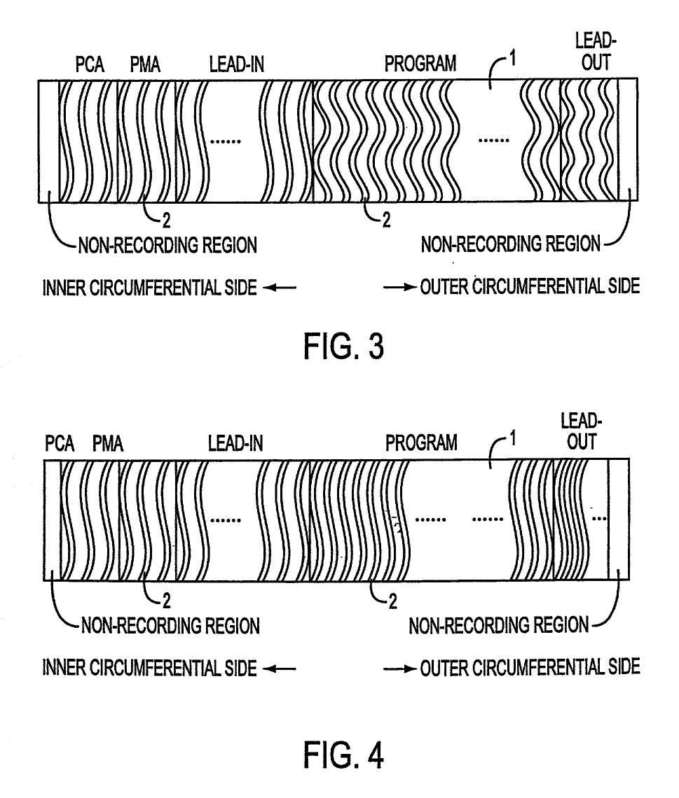

Next, the second embodiment of the present invention is described. The physical format of an optical recording medium according to the second embodiment is shown in FIG. 3.

According to the second embodiment of the invention, instead of making the track pitch narrow, the linear speed is decreased. Specifically, the linear speed of the optical recording medium in the PCA region, PMA region, and lead-in region is made about the same as in the prior art. On the other hand, in the program region and lead-out region, the linear speed becomes slower than in the PCA region, PMA region, and lead-in region. The reason is that the recording capacity can be increased because the recording density of the program region is increased and also area is saved in the lead-out region.

Furthermore, the reason for making the program region comparatively large with respect to the PCA region, PMA region, and lead-in region, is as follows.

In the recording and playback devices of the prior art, to recognize the optical recording medium 1, performing focusing as described hereinabove, tracking control is performed. Then, in the recording and playback device, an ATIP signal is obtained from a pre-groove obtained to cause rotation of the optical recording medium at a predetermined linear speed. In the prior at optical recording media, an ATIP signal is obtained which is a 22.05 kHz carrier frequency at a linear speed of 1.2 m/s-1.3 m/s. Nevertheless, when the linear speed is reduced in all regions of the optical recording medium in order to increase recording capacity, because the optical recording medium reaches the normal rotation speed at the rotary derive start time, the carrier frequency of the ATIP signal obtained from the optical detector becomes higher than 22.05 kHz. The circuit which controls the rotation of the optical recording medium may be capable of pulling in up to a sufficiently high frequency, but at a speed the same as the prior art optical disk, the signal obtained to rotate the optical disk of the present invention is not limited to pulling in to a high frequency. Then, due to not pulling in the ATIP signal, rotation control or pickup movement control of the optical recording medium become impossible.

Accordingly, in the second embodiment of the present invention, to reach conformity with all the recording and playback devices, in each region of the PCA region, PMA region, and lead-in region, the linear speed was made about the same as in the prior art optical recording media.

Furthermore, in the optical recording medium of the second embodiment of the present invention, or in the disk stamper used to manufacture the optical recording medium, when the linear speed is reduced, with regard to the direction of rotation of the medium, it becomes possible to reduce the length consumed in one period of the meander amplitude of the formed pre-groove. Accordingly, in the case of molding a disk or its stamper having a wobble-shaped pre-groove, the linear speed is reduced by making the length which is consumed in one period of the meander amplitude short.

The linear speed in the program groove was set in accordance with the following. In a prior art recording and playback device having an optical detector of 780 nm, NA=0.45, a minimum speed was found which has a length of about a minimum mark which can be resolved, the result being found that, if the linear speed is 0.90 m/s or more, resolution is possible. Consequently, by setting the linear speed of the program region in the that range, the memory capacity is markedly increased.

Furthermore, for the degree of modulation by a 3 T mark (termed “I3” hereinbelow), or the degree of modulation by an 11 T mark (termed “I11” hereinbelow), for the recording and playback device considered, the minimum linear speed to obtain a sufficient value was found. The result was that if the linear speed is 1.0 m/s or more, playback of a stable signal when reading from and writing to an optical recording medium was possible. Jitter at a speed of 35 ns or less could be reached at this speed, and it was possible to write and read out a good signal

Furthermore, the distribution of linear speed corresponding to the respective regions according to the second embodiment of the present invention is shown in FIG. 2(C). The linear speed is shown on the ordinate of FIG. 2(C).

In this manner, in the first or second embodiments of the present invention, by making the track pitch or linear speed or the program region smaller than that of the PCA region, PMA region, and lead-in region, a high density optical recording medium could be obtained and recording is possible with a prior art optical detector of about λ=780 nm, NA=0.45.

Moreover, by not only making either one of the track pitch or linear speed small in the program region, but by making both track pitch and linear speed smaller than in the PCA region, PMA region, and lead-in region, a further increase of recording capacity is possible. Furthermore, the optimum track pitch and linear speed in the program region are preferably, for the above reasons, set to a track pitch of between 1.2 μm and 1.3 μm, and a linear speed of 1.0 m/s or more. Furthermore, the upper limit of linear speed to add useful commercial value to an 8 cm CD-R or CD-RW may be 1.13 m/s or less.

Next, an optical recording medium is described according to a third embodiment of the present invention with increased memory capacity by modifying the abovementioned embodiment. This optical recording medium has, in the lead-out region, at least one of the track pitch and linear speed smaller than in the program region. This is because the standard set in the lead-out region is 1 minute and 30 seconds or more. Therefore, in a range which satisfies the recording time standard of the lead-out region, the area occupied by the lead-out region can be reduced and, because this portion can be used for the program region, the recording capacity of the program region can be increased

The distribution of track pitch or linear speed corresponding to the respective regions in an optical recording medium according to the third embodiment is shown in FIG. 2(D). Moreover, a change of the track pitch according to the third embodiment is shown in FIG. 4, which is a schematic diagram of the physical format of an optical recording medium.

Next, an optical recording medium is described in which the recording capacity of the program region is increased without making the track pitch or linear speed of the program region smaller than that of the PCA region, PMA region, and lead-in region.

This optical recording medium has at least one of the track pitch and linear speed smaller in the lead-out region than in the other regions. The distribution of track pitch or linear speed corresponding to the respective regions of this optical recording medium is shown in FIG. 2(E).

In addition, in a range which satisfies the recording time standard for the lead-out region, the area occupied by the lead-out region can be decreased, and because this portion can be utilized as a program region, the recording capacity of the program region can be increased.

Incidentally, by making the track pitch or linear speed in the program region as above-mentioned, i.e., less than in the PCA region, PMA region and lead-in region, the recording capacity in the program region can be increased. Preferably, the linear speed in the PCA region is the same as in the PCA region.

Usually, to calibrate the light power when writing on a CD-R or CD-RW optical recording medium, writing and reading on the PCA region are performed, and a suitable power is found for the respective medium. Then, when writing and reading on the program region and obtaining the recommended power value from the ATIP signal obtained from the pre-groove of the PCA region, some marks are written to the PCA region at a laser power, oscillating the value above and below this recommended value. Then, the optimum mark having the obtained power is written.

However, when the linear speed in the PCA region and the linear speed in the program region are different, a change in the power per unit area results and, thus, power writing on the program region becomes insufficient. In order to avoid this, the linear speed is preferably made the same in the program region and the PCA region.

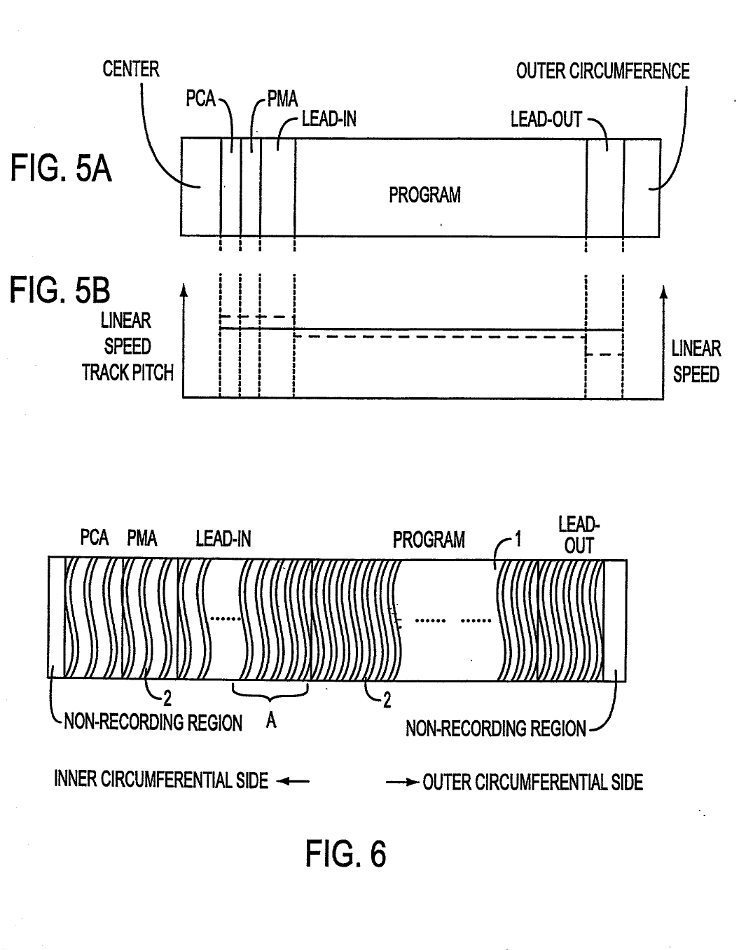

Moreover, so as not to impose a load on the motor disposed in the recording device or playback device, the PCA region, PMA region, lead-in region, and program region preferably run at the same linear speed. In contrast, regarding track pitch, a readable and writable extent having a margin can be disposed throughout the PCA region, PMA region, and lead-in region and by making the track pitch more narrow in the program region, the recording capacity can be increased. The distribution of track pitch and linear speed in the respective regions of an optical recording medium having such a constitution is shown in FIG. 5. Furthermore, the full line in FIG. 5 shows the linear speed and the dotted line in FIG. 5 shows the track pitch.

Accordingly, while fixing the linear speed, an optimum linear speed for maintaining sufficient recording capacity is preferably 1.0 m/s or more. Furthermore, the upper limit value of the linear speed may be 1.13 m/s or less to add commercial value to an 8 cm CD-R or CD-RW. Furthermore, it was discovered that, when writing at a high speed (particularly to a 20-fold extent), speed control becomes difficult at speeds above 1.16 m/s.

Furthermore, if the track pitch of the program region is reduced, for example, when recording in a groove, the width of the groove is preferably finer than the width of the land. In particular, in the case that the track pitch is reduced, crosstalk tends to worsen. To avoid this deterioration of crosstalk, by making the groove width narrow, i.e., within the range illuminated by the light spot, it becomes possible to make the proportion occupied by the mark formed in an adjacent groove small.

Accordingly, the effect of a mark formed in an adjacent groove becomes small and crosstalk is reduced.

Furthermore, if the track pitch is between 1.2 μm and 1.3 μm, the width of the portion in which recording pits are formed is preferably between 300 nm and 550 nm. Furthermore, the lower limit of 300 nm or more is a width at which the presence or absence of a mark can be resolved by an optical detector of wavelength λ=750 nm, numerical aperture NA=0.45.

Furthermore, this is not limited to the case of groove recording; in the case of land recording, by making the land width narrow, a similar effect can be expected. Moreover, in the case of a CD-R with a recording layer formed with colorant, the degree of modulation also becomes large at mark playback time.

Moreover, regarding the track pitch in the PCA region, PMA region, and lead-in region, in an embodiment in which the track pitch is wide, the characteristic features are as follows.

By increasing the track pitch of the PCA region which performs calibration, focusing of the PCA region becomes easy, and also effects from adjacent tracks are hardly received Accordingly, selection of the appropriate laser power for the medium is easy.

Moreover, focusing becomes easy in the PMA region as well, and program region written data which is written in the PMA region can be accurately read out, Accordingly, reliability is increased at the time of recording a postscript on the medium.

Furthermore, both the PCA region and the PMA region are mentioned, but with signals recorded in these regions the block error rate becomes low and both I3, I11 are within specification and have a margin. Accordingly, data recorded in the PCA region and PMA region can be read out with high accuracy and stable recording operations are performed in recording and playback devices.

Furthermore, according to the present invention, in the case of a CD-R with the track pitch made between 1.2 μm and 1.3 μm or less, the optimum power becomes lower than for a prior art CD-R to the extent that the track pitch is narrowed. Accordingly, the recommended power value in the ATIP signal in the lead-in region is preferably lower than the recommended power value for a prior art CD-R. Furthermore, the preferred recommended power range, in a laser power value at single speed, is between 4.9 mW and 6.5 mW.

With the abovementioned track pitch, when the recommended power reaches more than 6.5 mW, in the case of a CD-R, pits come to be formed in the land or groove on the unrecorded side. Accordingly, the block error rate increases. Furthermore, when the recommended power value becomes a normal 7.2 mW, the power range at which it is possible to calibrate in the PCA region becomes outside the optimum power value.

Furthermore, when the recommended power value becomes 4.9 mW or less, the pits now formed become too small, and good pits are not formed.

Because the optimum power for an optical recording medium formed with a prior art track pitch is 7.2 mW, the recommended power is initially set low and, by placing the lead-in region a meandering groove already formed corresponding to this power value in the lead-in region, the recording and playback device is able to accurately select the optimum power.

Moreover, in recent years, CD-RW have been proposed in which high speed recording and playback is possible. In particular, a 4- to 10-fold degree of reading speed is obtained. This standard is set in the Orange Book, Part 3, Vol. 2, Ver. 1.0. In this standard, a point of difference from the prior art CD-RW is a time jump of 30 seconds in the PCA region. The intermediate portion of the PCA region is a portion with no ATIP signal.

Only the lead-in region introduced in the prior art technology is wide. Otherwise, because the recording capacity is high, the track pitch or linear speed is reduced and the time jump portion is formed at a different position than heretofore. Accordingly, when trial writing in the PCA region, the possibility that stable control was not possible arose. However, this possibility does not arise in the present invention. In this manner, the optical recording medium of the present invention is a highly interchangeable optical recording medium.

Incidentally, in the case that the track pitch of the program region is narrowed, the effect of eccentricity in the medium increases. Therefore, in comparison with the PCA region, PMA region, and lead-in region, if the program region is narrowed, it is preferable for the amount of eccentricity to be 30 μm or less.

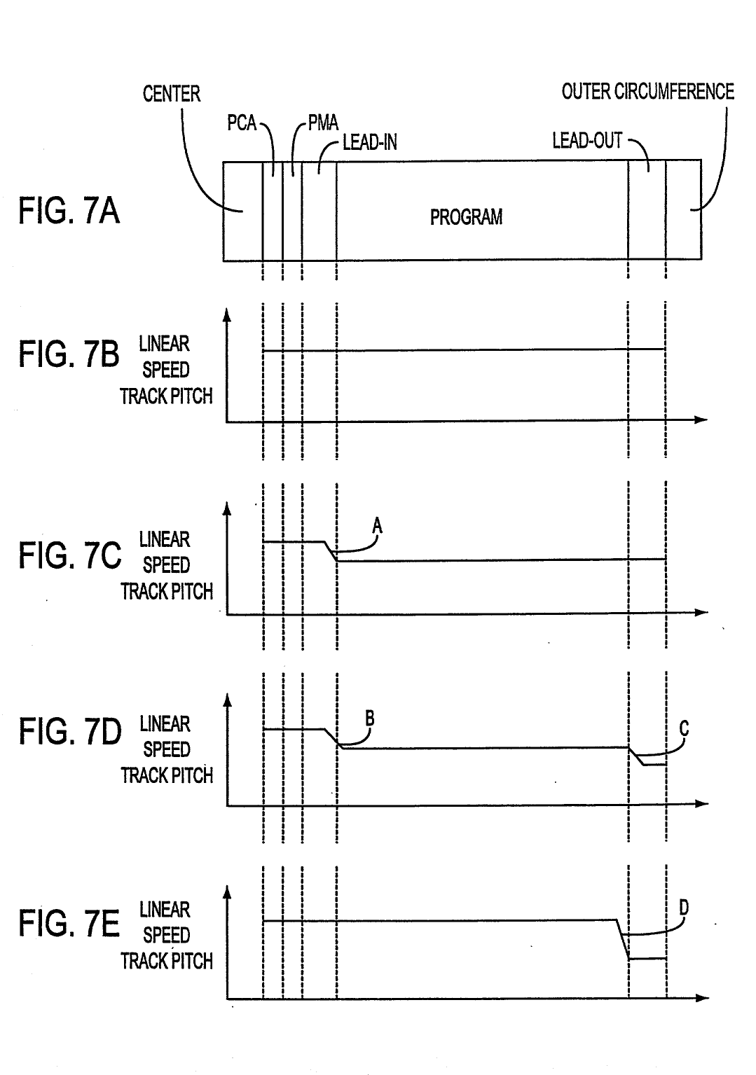

FIG. 6 is a schematic diagram of the physical format of an optical recording medium, represented by a CD-R and CD-RW, according to the fourth embodiment of the present invention. This fourth embodiment is the same as the first embodiment except for the following points; FIGS. 6 and 7 are also the same as FIGS. 1 and 2, except for the following points, and a description of the points which are the same is omitted herein.

In this fourth embodiment, in portions where the track pitch changes, the track pitch is made to change gradually. This region is termed the transition region of the track pitch. Moreover, as shown in FIG. 6, the track pitch transition region A is disposed in the lead-in region. In and after the latter half of the lead-in region, the change of the track pitch ends within the lead-in region- Because the track pitch is caused to gradually change in this manner, there is no possibility of sudden errors arising during recording and playback due to large external disturbances entering the tracking control device and tracking being disturbed. Furthermore, because the track pitch does not change in the program region, stable writing and reading become possible.

The location of the recording regions and the track pitch in the respective regions, according to the fourth embodiment are shown in FIG. 7(C).

Furthermore, FIG. 7(A) shows the location of the recording regions of the optical recording medium. From the center, there are shown in succession: a non-recording region which has no groove, the PCA region, the PMA region, the lead-in region, the program region, the lead-out region, and a non-recording region which has no groove.

FIGS. 7(B)-(E) are diagrams showing the distribution of track pitch or linear speed corresponding to the respective regions. FIG. 7(B) corresponds to a prior art CD-R where the track pitch and the linear speed are fixed in the PCA region, PMA region, lead-in region, program region, and lead-out region.

FIG. 7(C) corresponds to the optical recording medium of the fourth embodiment of the present invention where the track pitch in the PCA region, PMA region and lead-in region is wider than that in the program region so that data can be accurately read out from these regions.

In contrast to this, in the program region and lead-out region, the track pitch is more narrow than in the PCA region and PMA region. In this manner, the recording density of the program region is increased. Then, a track pitch transition region A is disposed in the latter half of the lead-in region and, thereafter, the track pitch gradually decreases within this transition region A and becomes a predetermined track pitch by the beginning of the program region. Accordingly, the responsiveness of the optical detector of the playback device or recording device is high and tracking errors hardly occur.

Next, a description is given of the optical recording medium according to the fifth embodiment of the present invention.

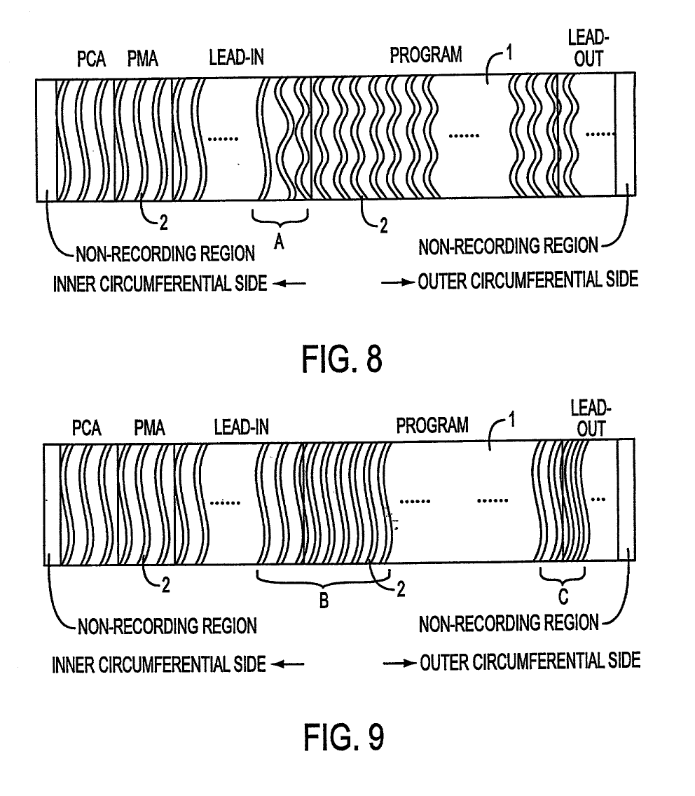

FIG. 8 shows the physical format of an optical recording medium according to the fifth embodiment. In this optical recording medium, the linear speed is reduced instead of narrowing the track pitch. Then, the resulting optical recording medium is the same as the optical recording medium of the second embodiment of the invention, with the exception of the following points. A description is omitted of the parts which are the same.

In the fifth embodiment, a linear speed transition region A is disposed between the program region and the lead-in region so as not to suddenly change the linear speed. Accordingly, a transition region which gradually changes the linear speed is provided so that a load is not imposed on the motor which rotates the medium or on its control device.

Furthermore, the distribution of linear speed corresponding to the respective regions in the configuration of the fifth embodiment of the present invention is shown in FIG. 7(C). Furthermore, at this time, the linear speed shown on the ordinate of FIG. 7(C) is considered.

Next, a description is given of the optical recording medium according to the sixth embodiment of the invention, with a memory capacity increased over that of the abovementioned fifth embodiment. In this embodiment, moreover, a transition region B for track pitch or linear speed is disposed between the lead-in region and the program region. Furthermore, a transition region C for track pitch or linear speed is disposed adjacent to the start portion of the lead-out region. Furthermore, in the optical recording medium of the sixth embodiment, the transition region B is formed so as to straddle the lead-in region and the program region. Then, the transition region C is present in the lead-out region only.

The distribution of track pitch or linear speed corresponding to the respective regions in the optical recording medium of the sixth embodiment is shown in FIG. 7(D). Moreover, a schematic diagram of the physical format of the optical recording medium when the track pitch changes according to the sixth embodiment is shown in FIG. 9.

The sixth embodiment differs from the third embodiment only in that a transition region is disposed; its other constitution or operational results are the same as in the third embodiment and, thus, their description is omitted. Furthermore, the object and operational result of disposing a transition region are the same as in the fourth and fifth embodiments.

Next, a description is given of a optical recording medium with increased recording capacity of the program region, without making the track pitch or linear speed smaller than in the PCA region, PMA region, or lead-in region.

In this optical recording medium, at least one of the track pitch and linear speed becomes smaller in the lead-out region than in the other regions, The distribution of track pitch or linear speed corresponding to the respective regions in this optical recording medium is shown in FIG. 7(E). Furthermore, a transition region D is formed in the terminal portion of the program region.

In this optical recording medium, the similar to as shown in FIG. 2(E), in a range which satisfies the standard for recording time of the lead-out region, the area occupied by the lead-out region can be made smaller, and because this portion can be used as a program region, the recording capacity of the program region can be increased.

Incidentally, if a transition region is not disposed in the program region, it is preferably disposed in the end portion of the lead-in region or in the lead-out region. For example, TOC data is written in the lead-in region, but the same data is repeatedly written until the entire lead-in region is filled. Therefore, because the necessary data is read out at the initial side of the lead-in region, the final side of the lead-in region becomes unnecessary. Accordingly, even when disposing the transition region in the lead-in region, adverse effects rarely occur. Moreover, because there is no reason for special data to be written into the lead-out region, even when disposing the transition region in the lead-out region, adverse effects rarely occur.

Furthermore, when disposing a transition region, it is preferable to make the linear speed the same throughout the PCA region, PMA region, lead-in region, and program region so that a load is not imposed on the motor for rotating the disk with the transition region disposed in the recording device or playback device. Alternatively, it is preferable to make the track pitch in the program region narrow for easily obtaining a margin to write and read throughout the PCA region, PMA region and the lead-in region.

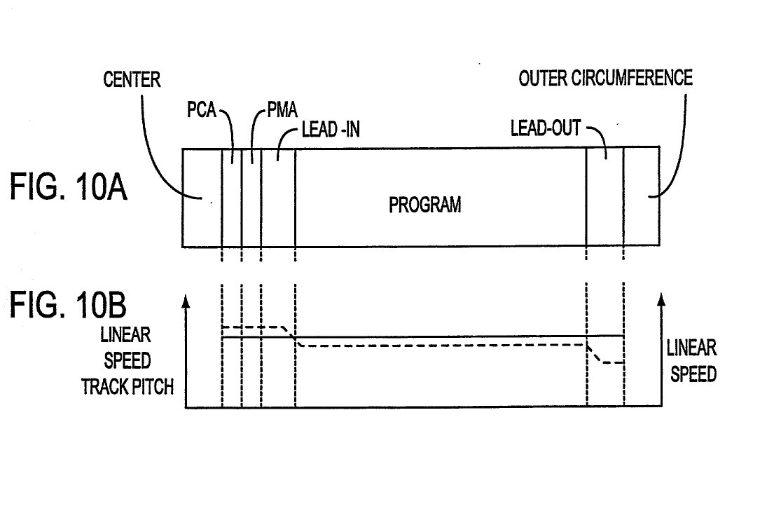

The distribution of track pitch and linear speed corresponding to the respective regions of the optical recording medium having such a constitution as shown in FIGS. 10(A) and 10(B). Furthermore, showing the optical recording medium in FIGS. 10(A) and 10(B), the solid line shows the linear speed and the dotted line shows the track pitch. Moreover, the track pitch transition regions, disposed in the lead-in region and the lead-out region, are such that the track pitch does not change in the program region. Preferably, the range of linear speed is as mentioned hereinabove.

Moreover, in the case of manufacturing a stamper for this kind of disk, a process is performed corresponding to grooves or pre-pits by a laser cutting machine or the like. In these process machines, there is a table movement type in which a process is performed wherein a table which fixes the stamper moves, and a pickup movement type, which causes a laser or the like process tool to move. In the case of changing the track pitch with the pickup movement type, the response is fast and the following accuracy is good. However, because the table movement method is superior from the aspect of processing accuracy of the whole disk, the proper use of both types as appropriate is preferable.

Furthermore, to form the track pitch with high accuracy, in the case of using the table movement method, the drive circuit driving the table, according to the prior art, does not include a method of only inputting the signal relating to the track pitch one time. With respect to the position in the radial direction, a controller is necessary to input the track pitch signal at any time while detecting the position in the radial direction and inputting the track pitch signal according to this position.

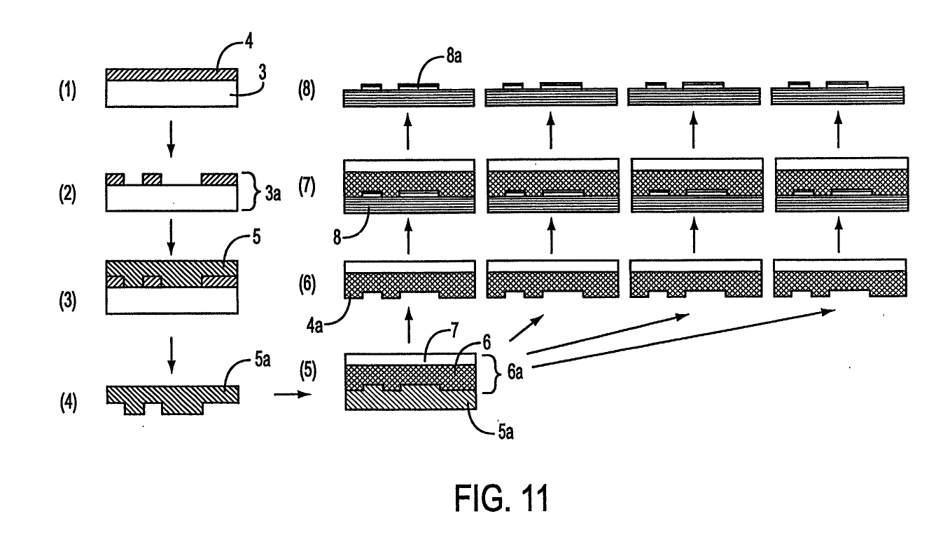

A description will next be given, using FIG. 11, of the method of manufacturing a stamper which can be applied to the optical recording media of the abovementioned first through sixth embodiments of the present invention.

A soda-lime glass plate is processed as substrate material to a donut-shaped disk, as substrate 3. After this, the substrate surface is accurately polished to a surface roughness Ra=1 nm or less. After washing, primer and photoresist 4 are spin coated in succession onto the substrate surface. Prebaking and a photoresist layer 2 of about 200 nm thickness is formed on the respective substrate 3 in operation (1).

Next, using a laser cutting device, the photoresist 4 on the substrate 3 is exposed. The exposure pattern is a pattern corresponding to the grooves and prepits of the optical recording medium according to the present invention.

At the end of exposure, the photoresist 4 on the substrate 3 is developed with various alkaline developing solutions. The resist surface is spin washed, and postbaked thereafter. A resist pattern is thereby formed in operation (2).

Next, this substrate 3a is set in a sputtering device and an Ni layer (electrically conductive layer) is deposited and adhered on the surface. The electroconductive treatment in this manner ends, Then, Ni electroplating is performed by passing an electric current therethrough and a predetermined thickness of a Ni plated layer 5 is thereby obtained in operation (3). Then, this Ni plated layer 5 is peeled from the substrate 3a, and a first molding die 5a is obtained in operation (4).

A protective coating (as an example, commercial name “CleanCoat S” by Fine Chemical Japan Co.) is coated on the rough surface of the first molding die 5a by a spin coating method. After coating, the coating film dries naturally. The rough surface is thereby covered with a protective coating. After polishing the back surface of the first molding die 5a, dieing-out its internal diameter and external diameter, the first molding die 5a is removed. In this manner, a donut-shaped first molding die 5a is completed.

The substrate 3a does not become damaged after the first molding die 5a is peeled off. Consequently, after washing the substrate 3a, the process can be repeated and plural first molding dies 5a can be obtained. When a stainless steel plate is affixed with epoxy adhesive to the back surface of the first molding die 5a, the flatness of the first molding die 5a is improved.

Next, an ultraviolet light setting resin solution is prepared. As a resin solution, when considering heat or light absorbing properties, mold separation, light resistance, durability, and hardness, it is preferable to use one with color number (APHA) 30-50, refractive index at 25° C. 1.4-1.8. Preferably, the specific gravity of the resin solution is 0.8-1.3, the viscosity at 25° C. is 10-4800 cps degrees, from the standpoint of transferability.

In addition, a soda-lime plate glass disk 7 is prepared. Then, the surface is washed, a silane coupling agent, which is a primer, is coated on and then baked. Then, a resin solution is dripped onto the first molding die 5a on the rough surface. The glass plate 7 is then pressed on from above. The resin solution 6 is sandwiched between the glass disk 7 and the first molding die 5a. At this time, care is taken to ensure that there are no bubbles in the resin solution 6. Furthermore, the viscous resin solution 6 is spread out uniformly on the first molding die 5a by pressing the glass disk 7.

Ultraviolet light is irradiated onto the resin solution 6 from a mercury lamp through the glass disk 7. Thereby, the resin is hardened and a second molding die 6a made of a hard resin layer is formed in operation (5). Next, the second molding die 6a is peeled from the first molding die 5a. The second molding die 6a, with the glass disk 7 as a base, become an integral structure in operation (6).

The remaining first molding die 5a, after being separated by peeling, is undamaged and can be used repeatedly. Therefore, plural second molding dies 6a can be formed from one first molding die 5a. The manufacture of the second molding dies 6a is easy and one can be manufactured in 15-60 minutes.

Next, with a second molding die 6a as an original, a third molding die made of metal is formed. The manufacturing method is the same as the manufacturing method of the first molding die 5a, as described hereinabove. Namely, a second molding die 6a is set in a sputtering device and an Ni layer 8 (electrically conducive layer) is deposited and adhered on the surface. The electroconductive treatment in this manner ends. Then, Ni electroplating is performed by passing an electric current therethrough and a predetermined thickness of an Ni plated layer 8 is obtained in operation (7). Then, this Ni plated layer 8 is peeled from the second molding die 6a, and a third molding die 8a is obtained in operation (8).

A protective coating (as an example, commercial name “CleanCoat S” by Fine Chemical Japan Co.) is coated on the rough surface of the third molding die 8a by a spin coating method. After coating, the coating film dries naturally. The rough surface is thereby covered with a protective coating. After polishing the back surface of the third molding die 8a, dieing-out its internal diameter and external diameter, the third molding die 8a comes off. In this manner, a donut-shaped third molding die 8a is completed. This third molding die is used as a stamper for manufacturing the actual disks.

Furthermore, using a manufacturing method of this kind, it is possible to manufacture an optical recording medium where the track pitch and linear speed vary in the program region, as described hereinbelow.

As abovementioned, in the case of an optical recording medium with the track pitch narrowed in the program region, the amount of eccentricity had to be 30 μm or less, but the present inventors found that in order to satisfy this amount of eccentricity, the amount of eccentricity of this stamper had to be 10 μm or less. Accordingly, an eccentricity amount of 10 μm or less is preferable.

By setting the track pitch of the program region between 1.2 μm and 1.3 μm, and the linear speed of the program region to between 1.0 and 1.13 μm, it is possible to read data recorded on the program region with a playback device after writing to the program region with a recording device, based on compact disk standards, resulting in a higher recording capacity than with a prior art compact disk. In particular, by applying these ranges to an 8-cm CD-R and CD-RW, the usefulness of a CD-R/RW is greatly increased.

Incidentally, in a recording and playback device having a track pitch less than 1.2 μm, wavelength λ=780 nm, and a numerical aperture NA=0.45, if the track pitch is 1.1 μm or more, the peak-to-peak value (push-pull signal) obtained when passing across a track, in comparison with the signal obtained from a reflecting signal with no groove, can obtain a sufficient degree of tracking. Furthermore, a track pitch of 1.15 μm or more is preferred.

Accordingly, if the track pitch is 1.1 μm or more (preferably, 1.15 μm or more), because tracking is possible, tentatively recording and playback becomes possible. Nevertheless, as described hereinabove, the productivity of compact disks including CD-R or CD-RW is reduced. Consequently, the commercial value of low cost CD-R or CD-RW decreases. Accordingly, to obtain the same productivity as with the prior art CD-R or CD-RW, and also to attain high density recording, it was found that a track pitch of 1.2 μm or more is preferable.

Moreover, according to the preferred embodiments of the present invention, the track pitch is preferably made less than 1.3 μm. The reason for this is also described in conjunction with the first embodiment of the invention. Thereby, tracking is possible even in using the present small 3 beam method.

Moreover, a linear speed of 1.0 m/s or more is preferable. In a track pitch of less than 1.0 μm, with a recording and playback device having an optical detector of wavelength λ=780 nm, and a numerical aperture NA=0.45, if the track pitch is 0.90 μm or more, the minimum mark does not become smaller than the resolution of the optical detector.

Accordingly, it is possible to read out a minimum mark with a prior art playback device, but in the present invention, the minimum linear speed was found, accepting the range of 0.30-0.6 for I3 or I11, such that jitter becomes 35 ns or less and the average value of the block error rate is less than 50 per second. Thereby, playback was found to be possible with a linear speed of 1.0 m/s. This is because, when the linear speed is too low, the linear speed becomes lower than the lower limit value of the rotation speed of a motor capable of stable rotation in recording or playback, particularly outside of the program region.

Accordingly, in a CD-R/RW having 8 cm diameter, if the linear speed is 1.0 m/s, it is considered that, because the rotation speed of the motor can rotate stably at a rotation speed outside of the program region, it is tolerable that jitter and the like properties do not decrease.

Next, it is preferable to make the upper limit value of the linear speed 1.13 m/s or less. Thereby, it is possible for the recording time of an 8-cm diameter CD-R/RW to be 30 minutes or more. Incidentally, the recording format of CD digital audio is “sampling frequency 44.1 kHz, quantization number 16 bits, 2 channels (right and left)”. Moreover, the CD-ROM format, namely in the case of recording in the ISO 9660 Mode-1 format, has more than a 265 MB storage capacity.

Further, in the consumer application of CD-R/RW data recording with a data quantity of 80 minutes (700 MB) of a CD-R disk, the disk is only half utilized. The reason is that the software heretofore has had no need for a large capacity because handling a large capacity is not necessary for notebooks, personal computers or mobile phones and the like portable data terminals. On the contrary, having a large capacity is inconvenient.

Consequently, using a standardized 8-cm size CD, which is smaller than the widely used CD-R/RW, to obtain a necessary sufficient capacity in smaller media, it was found that a CD-R/RW with upwards of 265 MB of storage capacity attained the objectives of the present invention without introducing actual hindrances.

The use of CD-R/RW optical recording media to store images or music data by consumers is popular. Generally, in the case of the digital audio which is now becoming widespread, one hour of recording is possible. The recording capacity at present in use is 300 MB. Moreover, the capacity necessary to store 1 hour of moving images with MPEG 4 is 300 MB. Consequently, with an 8-cm CD-R/RW, which is a small medium, by setting the track pitch and linear speed as above, the disk can have about the same recording capacity. Accordingly, it is also possible to use an 8-cm CD-R/RW as a recording medium for digital video.

Then, because it is possible to playback this medium with the widely diffused recording and playback devices having an installed optical detector for wavelength λ=780 nm, numerical aperture NA=0.45, its use value increases. Furthermore, to obtain a recording capacity equivalent to a digital videotape, it is necessary to be able to store 300 MB. However, this equals 34 minutes of capacity for the abovementioned CD digital audio format. Accordingly, 34 minutes or more of capacity is preferable. However, because recording and playback become difficult with a track pitch or linear speed needed to provide more than 40 minutes of capacity on an 8-cm CD-R/RW, the capacity is preferably set to 40 minutes or less.

In this manner, it is possible by preferred embodiments of the present invention to obtain an 8-cm CD-R/RW having a recording capacity equivalent to a digital videotape while being more compact than the widely diffused 12-cm CD-R/RW.

Namely, with an optical recording medium having an 80 mm diameter, when the track pitch and linear speed are set so that the recording time is between 30 minutes and 40 minutes, the push-pull signal and the playback signal of the formed pits are obtained having a margin equal to that of a prior art recording device and playback device having a pickup for a wavelength of 780 nm and a numerical aperture of 0.45.

Recording and playback are possible even with an optical recording medium having a longer recording time than indicated above, but in comparison with an optical recording medium having a recording time greater than this range, a good quality signal is obtained.

Furthermore, the characterizing features of the above-described inventions are not limited to only CD-R and CD-RW; they are also applicable to optical data recording media formed by only a lead-in region, a program region, and a lead-out region. Consequently, to increase in data capacity, the track pitch or linear speed of the program region is made slow, or the track pitch or linear speed of the lead-out region is made slow, providing for an increase of recording capacity in read-only media.

Furthermore, regarding recordable optical data recording media, in addition to making the program region or the lead-out region larger than the PCA region, PMA region and lead-in region, an invention is also disclosed which is necessary in order to attain stable and reliable recording to an optical data recording medium.

For example, an optical data recording medium has the track pitch or linear speed of the PCA region made greater than those of other regions, or an optical data recording medium has the track pitch or linear speed of the PMA region made greater than those of other regions. Furthermore, it is inventive to make both the PCA region and the PMA region larger than the other regions.

By means of these inventions, setting the track pitch or linear speed in the PCA region to the same value as in the prior art CD-R, and making the track pitch or linear speed small of regions other than this, an increase of the recording capacity and a calibration of the laser intensity when writing are performed. In particular, by increasing the track pitch or linear speed of the PCA region, the size of the marks formed in the PCA region also becomes large. Accordingly, an evaluation becomes easy of marks sufficiently formed even with a prior art optical pickup. A suitable laser power can also be selected if marks are accurately evaluated from this. Therefore, the quality of marks formed in the program region and the like other regions is increased.

Moreover, as previously described regarding the track pitch or linear speed of the PMA region, by making these larger than in the other regions, data written in the PMA region can also be accurately read out. Consequently, because writing to the optical data recording medium becomes possible based on the data of the accurately written PMA region, addition becomes possible more stably to the accurate optical data recording medium.

Moreover, even if the standard of the present compact disks or DVDs is to some degree unreliable, the advent can be expected of recording and playback devices capable of sufficiently recording and playing back. With respect to such devices, making the track pitch or the linear speed of at least the PCA region or the PMA region large, optical data recording media can be obtained which can stably perform recording and playback in a reliable state.

Next, examples relating to preferred embodiments of the present invention are shown hereinbelow. In the following examples, there are no particular disclosures with regard to the PCA region and PMA region, but the optical disk and stamper of the examples are respectively formed so as to come within the standard. Furthermore, because the interval existing from the groove start to the PCA region start can also be used as an optical disk, the PCA region start region and the like are not particularly specified herein.

### EXAMPLE 1

The optical disk recorded with a groove record was manufactured according to a preferred embodiment of the present invention. The size of the optical disk is 80 mm. First, the stamper of the present invention was prepared. It is important to note that during the process of recording grooves in the photoresist original disk, the ATIP referenced in a CD-R and CD-RW format was recorded by groove wobbling (meandering groove). Since the process is the same for the following examples 2 through 13, and because only the conditions differ as described hereinbelow, a description of the above process will not be repeated for each example.

The following conditions were set: groove start and ATIP start radius at 21 mm, grove end and ATIP end radius at 39 mm, lead-in region start time at 97:27:00, program region start time at 00:00:00, lead-out region start time (last possible start time of readout area) at 26:30:00, linear speed (single speed) at 1.2 m/s with the track pitch from groove start position to lead-in start position of 1.52 μm, linear speed (single speed) at 1.2 m/s with the track pitch of lead-in region at 1.52 μm, linear speed (single speed) at 1.2 m/s with the track pitch of the program region at 1.34 μm, and linear speed (single speed) at 1.2 m/s with the track pitch of the lead-out region at 1.34 μm.

After development of the original disk exposed under these conditions, the following process sequence was performed: an electrically conductive Ni film was sputtered, nickel electroplating was performed, the nickel plating was peeled from the original disk, the photoresist was removed, the surface protective film coating was washed, the back surface was polished, back surface protective film coating was applied, inner and outer diameter dieing-out, the protective film was peeled off both surfaces, and the surfaces were washed. Setting this stamper in an injection molding device (SD40 alpha, made by Sumitomo Heavy Machine Industry) and performing injection molding, mass producing polycarbonate substrate, long playing CD-R according to the present invention were manufactured on a CD-R production line (Shingyuras Co.).

Colorant phthalocyanine dye (Super Green, Ciba Speciality Chemicals Co.), solvent DBE, protective coat lacquer UV setting type coat material (DSM Co.), coating on this, printing Empire Ink Co. Data was recorded on this long playing CD-R by a 1-12 fold speed CD-R writer (Plextor Co.), and assessment of recording and playback was performed by a CD-R standard inspection device (CD-CATS, Audio Development Co.). The results of this were: lead-in region radius at 22.95 mm, within specification and with no problems; program region radius at 24.9 mm, within specification and with no problems.

This CD-R had a time 3 minutes longer than the prior art limiting time of 23 minutes, that is, it can record 26 minutes (230 MB) of long playing high capacity record data, but the jitter of this recording disk was low, 20 ns for both land jitter and pit jitter, and pit deviation and land deviation were also within specification. I3 and I11 were also both within specification. Reflectivity was also 71% and within specification. A low BLER was obtained and the push-pull signal also had no problems. In addition, tracking was good. These properties were maintained from 1-fold speed to 12-fold speed writing. Furthermore, there were no faults in 16-fold speed writing or 20-fold writing by a Pulse Deck DDU1000, and it was confirmed that the properties were maintained.

In a recording and playback device performing tracking by the 1-beam method, there were no faults, but they were numerous in a recording and playback device performing tracking by the 3-beam method and tracking became unstable. Furthermore, the optimum laser power when reading was 6.5 mW at this time. Furthermore, the groove bottom width was 550 nm.

### EXAMPLE 2

An optical disk according to a preferred embodiment of the present invention was manufactured in this example. The size of the optical disk was 80 mm. The groove start and ATIP start radius was 21 mm, the groove end and ATIP end position was 39 mm, the lead-in region start time was 97:27:00, the program region start time was 00:00:00, the lead-out region start time (last push-pull start time of readout area) was 30:30:00, the linear speed (single speed) was 1.2 m/s with the track pitch from the groove start position to the lead-in start position being 1.52 μm, the linear speed (single speed) was 1.2 m/s with the track pitch of the lead-in region at 1.52 μm, the linear speed (single speed) was 1.2 m/s with the track pitch of the program region being 1.17 μm, and the linear speed (single speed) was 1.2 m/s with the track pitch of the lead-out region being 1.17 μm.

After this, by the same process as described in connection with example 1, a long playing CD-R was manufactured. Data was recorded on this long playing CD-R by a 1-12 fold speed CD-R writer (Plextor Co.), and assessment of recording and playback was performed by a CD-R standard inspection device (CD-CATS, Audio Development Co.).

This CD-R had a time 7 minutes longer than the prior art limiting time of 23 minutes, that is, the CD-R can record 30 minutes (230 MB) of long playing high capacity record data. The results obtained were the same as in example 1. These properties were maintained from 1-fold speed to 12-fold speed writing. Furthermore, there were no faults in 16-fold speed writing or 20-fold writing by a Pulse Deck DDU1000. Further it was confirmed that the properties were maintained.

In particular, the peak-to-peak value of the signal obtained when an optical detector of wavelength 780 nm and a numerical aperture of 0.45, passed across a track of any nature compared with the magnitude of a signal obtained from a mirror surface portion, was 0.5. Thereby, a sufficiently large tracking signal was obtained. Accordingly, an optical disk was obtained which had a slightly worse but usable performance with a standard recording and playback device. Furthermore, the optimum laser power when writing at this time was 5.4 mW. The groove bottom width was 390 nm and the productivity of injection molding of the plastic substrate was inferior to that of example 1.

### EXAMPLE 3

An optical disk according to a preferred embodiment of the present invention was manufactured in this example. The size of the optical disk was 80 mm. The groove start and ATIP start radius was 21 mm, the groove end and ATIP end position was 39 mm, the lead-in region start time was 97:27:00, the program region start time was 00:00:00, the lead-out region start time (last push-pull start time of readout area) was 30:00:00, the linear speed (single speed) was 1.2 m/s with the track pitch from the groove start position to the lead-in start position being 1.52 μm, the linear speed (single speed) was 1.2 m/s with the track pitch of the lead-in region being 1.52 μm, the linear speed (single speed) was 0.92 m/s with the track pitch of the program region being 1.52 μm, and the linear speed (single speed) was 0.92 m/s with the track pitch of the lead-out region being 1.52 μm.

After this, a long playing CD-R according to the present invention was manufactured by the same process as described in example 1.

Data was recorded on this long playing CD-R by a 1-12 fold speed CD-R writer (Plextor Co.), and assessment of recording and playback was performed by a CD-R standard inspection device (CD-CATS, Audio Development Co.).

This CD-R had a time 7 minutes longer than the prior art limiting time of 23 minutes, that is, the CD-R can record 30 minutes (230 MB) of long playing high capacity record data, but as experimental results, in comparison with those stated for example 1, jitter due to the playback machine type, and the I3, I11 block error rate were lower. These properties were maintained from 1-fold speed to 12-fold speed writing. Furthermore, there were no faults in 16-fold speed writing or 20-fold writing by a Pulse Deck DDU1000. It was confirmed that the properties were maintained as well. The optimum laser power when writing at this time was 6.5 mW and the groove bottom width was 550 nm.

### EXAMPLE 4

An optical disk according to a preferred embodiment of the present invention was manufactured in this example The size of the optical disk was 80 mm. The groove start and ATIP start radius was 21 mm, the groove end and ATIP end position was 39 mm, the lead-in region start time was 97:27:00, the program region start time was 00:00:00, the lead-out region start time (last push-pull start time of readout area) was 40:00:00, the linear speed (single speed) was 1.2 m/s with the track pitch from the groove start position to the lead-in start position being 1.52 μm, the linear speed (single speed) was 1.2 m/s with the track pitch of the lead-in region being 1.52 μm, the linear speed (single speed) was 0.95 m/s with the track pitch of the program region being 1.10 μm, and the linear speed (single speed) was 0.95 m/s with the track pitch of the lead-out region being 1.10 μm.

After this, a long playing CD-R according to the present invention was manufactured by the same process as in example 1.

Data was recorded on this long playing CD-R by a 1-12 fold speed CD-R writer (Plextor Co.), and assessment of recording and playback was performed by a CD-R standard inspection device (CD-CATS, Audio Development Co.). This CD-R had a time 17 minutes longer than the prior art limiting time of 23 minutes, that is, the CD-R can record 40 minutes (230 MB) of long playing high capacity record data. However, jitter and the I3, I11 block error rate were inferior to those of example 1.

Nevertheless, in the case of 16-fold writing and 20-fold speed writing by a Pulse Deck DDU1000, it was found that errors arose during reading in about 5% of the whole disk. Furthermore, for the optical disk in this example, the productivity of injection molding the plastic substrate was inferior to that of example 1. Furthermore, the optimum laser power when writing at this time was 4.9 mW and the groove bottom width was 300 nm.

### EXAMPLE 5

An optical disk according to a preferred embodiment of the present invention was manufactured in this example. The size of the optical disk was 80 mm. The groove start and ATIP start radius was 21 mm, the groove end and ATIP end position was 39 mm, the lead-in region start time was 97:27:00, the program region start time was 00:00:00, the lead-out region start time (last push-pull start time of readout area) was 30:00:00, the linear speed (single speed) was 1.2 m/s with the track pitch from the groove start position to the lead-in start position being 1.52 μm, the linear speed (single speed) was 1.2 m/s with the track pitch of the lead-in region being 1.52 μm, the linear speed (single speed) was 1.2 m/s with the track pitch of the program region being 1.34 μm, and the linear speed (single speed) was 1.0 m/s, with the track pitch of the lead-out region being 0.74 μm.

After this, a long playing CD-R according to the present invention was manufactured by the same process as in example 1. Data was recorded on this long playing CD-R by a 1-12 fold speed CD-R writer (Plextor Co.), and assessment of recording and playback was performed by a CD-R standard inspection device (CD-CATS, Audio Development Co.).

This CD-R had the same recording capacity as that of example 1, and the experimental results were also the same as given for example 1. These properties were maintained from 1-fold speed to 12-fold speed writing. Furthermore, there were no faults in 16-fold speed writing and 20-fold writing by a Pulse Deck DDU1000, and it was confirmed that the properties were maintained.

Furthermore, in a playback machine a three-spot tracking method, effects of adjacent tracks were received and tracking was imperfect. Furthermore, the optimum laser power when writing at this time was 6.5 mW and the groove bottom width was 500 nm.

### EXAMPLE 6

An optical disk according to a preferred embodiment of the present invention was manufactured in this example. The size of the optical disk was a card type. Firstly, a stamper was prepared according to the present invention. In the process of recording grooves in the photoresist original disk, the ATIP, which was referenced in a CD-R and CD-RW format, was recorded by groove wobbling (meandering groove). The process is the same for the following example 1, and because only the conditions differ hereinbelow, a description of the above process is omitted in the description of example.

The groove start and ATIP start radius was 21 mm, the groove end and ATIP end position was 39 mm, the lead-in region start time was 97:27:00, the program region start time was 00:00:00, the lead-out region start time (last push-pull start time of readout area) was 7:30:00, the linear speed (single speed) was 1.2 m/s with the track pitch from the groove start position to the leaden start position being 1.52 μm, the linear speed (single speed) was 1.2 m/s with the track pitch of the lead-in region being 1.52 μm, the linear speed (single speed) was 1.2 m/s with the track pitch of the program region being 1.17 μm, linear speed (single speed) was 1.2 m/s with the track pitch of the lead-out region being 1.17 μm.

After this, a long playing CD-R according to the present invention was manufactured by the same process as in example 1.

Data was recorded on this long playing CD-R by a 1-12 fold speed CD-R writer (Plextor Co.), and assessment of recording and playback was performed by a CD-R standard inspection device (CD-CATS, Audio Development Co.). This CD-R had, in comparison with the prior art limiting time of 5 minutes, a time about twice as long, that is, the CD-R can record 7 minutes (65 MB) of long playing high capacity record data, but as experimental results, completely the same performance was obtained as given for example 1.

These properties were maintained from 1-fold speed to 12-fold speed writing. Furthermore, there were no faults in 16-fold speed writing and 20-fold writing by a Pulse Deck DDU1000. The optimum laser power when writing at this time was 5.4 mW and the groove bottom width was 390 nm.

### EXAMPLE 7

An optical disk according to a preferred embodiment of the present invention was manufactured in this example. The size of the optical disk was a card type. The groove start and ATIP start radius was 21 mm, the groove end and ATIP end position was 39 mm, the lead-in region start time was 97:27:00, the program region start time was 00:00:00, the lead-out region start time (last push-pull start time of readout area) was 10:05:00, the linear speed (single speed) was 1.2 m/s with the track pitch from the groove start position to the lead-in start position being 1.52 μm, the linear speed (single speed) was 1.2 m/s with the track pitch of the lead-in region being 1.52 μm, the linear speed (single speed) was 0.95 m/s with the track pitch of the program region being 1.10 μm, and the linear speed (single speed) was 0.95 m/s with the track pitch of the lead-out region being 1.10 μm.

After this, a long playing CD-R according to the present invention was manufactured by the same process as in example 1. Data was recorded on this long playing CD-R by a 1-12 fold speed CD-R writer (Plextor Co.), and assessment of recording and playback was performed by a CD-R standard inspection device (CD-CATS, Audio Development Co.). This CD-R had, in comparison with the prior art limiting time of 5 minutes, a time about twice as long, that is, the CD-R can record 10 minutes (100 MB) of long playing high capacity record data.

As experimental results, jitter and the I3, I11 block error rate were found to be inferior to those of example 1. Moreover, there was a reduction of productivity of the plastic substrate injection molding. Then, in the case of 16-fold writing and 20-fold speed writing by a Pulse Deck DDU1000, it was found that errors arose during reading in about 5% of the whole disk. Furthermore, the optimum laser power when writing at this time was 4.9 mW and the groove bottom width was 300 nm.

### EXAMPLE 8

An optical disk according to a preferred embodiment of the present invention was manufactured in this example. The size of the optical disk was 80 mm. The groove start and ATIP start radius was 21 mm, the groove end and ATIP end position was 39.1 mm, the lead-in region start time was 97:18:00, the program region start time was 00:00:00, the lead-out region start time was 34:02:00, the linear speed (single speed) was 1.11 m/s with the track pitch from the groove start position to the lead-in start position being 1.50 μm, the linear speed (single speed) was 1.11 m/s with the track pitch of the lead-in region being 1.50 μm, the linear speed (single speed) was 1.11 m/s with the track pitch of the program region being 1.23 μm, and the linear speed (single speed) was 1.23 m/s with the track pitch of the lead-out region being 1.23 μm.

After this, a long playing CD-R according to a preferred embodiment of the present invention was manufactured by the same process as in example 1. Data was recorded on this long playing CD-R by a 1-12 fold speed CD-R writer (Plextor Co.), and assessment of recording and playback was performed by means of a CD-R standard inspection device (CD-CATS, Audio Development Co.).

The process resulted in a lead-in region radius of 22.97 mm, which was within specification, and no problems were experienced. The program region radius was 24.81 mm, which was within specification, and no problems were detected. Moreover, this CD-R had a time 11 minutes longer than the prior art limiting time of 23 minutes, that is, the CD-R can record 34 minutes (298 MB) of long playing high capacity record data, but the jitter of this recording disk was low, for example, 20 ns for both land jitter and pit jitter.

Moreover, pit deviation and land deviation were also within specification. Further, I3 and I11 were both within specification and reflectivity was 71%, also within specification. Furthermore, a low BLER was obtained, the push-pull signal also experienced no problems, and tracking was good. These properties were maintained from 1-fold speed to 12-fold speed writing. Furthermore, there were no faults in 16-fold speed writing and 20-fold speed writing by a Pulse Deck DDU1000, and it was confirmed that the properties were maintained. The optimum laser power when reading was 5.9 mW and the groove bottom width was 500 nm.

### EXAMPLE 9

An optical disk according to a preferred embodiment of the present invention was manufactured in this example. The size of the optical disk was 80 mm, the groove start and ATIP start radius was 21 mm, the groove end and ATIP end position was 39.1 mm, the lead-in region start time was 97:27:00, the program region start time was 00:00:00, the lead-out region start time was 34:07:00, the linear speed (single speed) was 1.16 m/s with the track pitch from the groove start position to the lead-in start position being 1.50 μm, the linear speed (single speed) was 1.16 m/s with the track pitch of the lead-in region being 1.50 μm, linear speed (single speed) was 1.16 m/s with the track pitch of the program region being 1.18 μm, and the linear speed (single speed) was 1.16 m/s with the track pitch of the lead-out region being 1.18 μm.

After this, a long playing CD-R according to a preferred embodiment of the present invention was manufactured by the same process as in example 1. Data was recorded on this long playing CD-R by a 1-12 fold speed CD-R writer (Plextor Co.), and assessment of recording and playback was performed by a CD-R standard inspection device (CD-CATS, Audio Development Co.). The results of this were that the lead-in region radius was 22.99 mm, which was within specification, and no problems were detected. The program region radius was 24.84 mm, which was within specification and no problems were detected.

Moreover, although this CD-R had a time 11 minutes longer than the prior art limiting time of 23 minutes, that is, the CD-R could record 34 minutes (298 MB) of long playing high capacity record data, jitter was low, for example, 18 ns for both land jitter and pit jitter. Moreover, pit deviation and land deviation were also within specification and I3 and I11 were also both within specification. Reflectivity was 72%, which was within specification. Furthermore, a low BLER was obtained, and no problems were detected With the push-pull signal and tracking was good. These properties were maintained from 1-fold speed to 12-fold speed writing. Furthermore, there were no faults in 16-fold speed writing or 20-fold writing by a Pulse Deck DDU1000, and it was confirmed that the properties were maintained.

However, in comparison with example 1, there was a reduction of productivity of the plastic substrate injection molding. Furthermore, the optimum laser power when reading was 4.9 mW. The groove bottom width was 390 nm.

### EXAMPLE 10

An optical disk according to a preferred embodiment of the present invention was manufactured in this example. The size of the optical disk was 80 mm. The groove start and ATIP start radius was 21 mm, the groove end ATIP end position was 39.2 mm, the lead-in region start time was 97:18:15, the program region start time was 00:00:00, the lead-out region start time was 34:02:00, the linear speed (single speed) was 1.13 m/s with the track pitch from the groove start position to the lead-in start position being 1.35 μm, the linear speed (single speed) was 1.13 m/s with the track pitch of the lead-in region being 1.35 μm, the linear speed was (single speed) was 1.13 m/s with the track pitch of the program region being 1.25 μm, and the linear speed (single speed) was 1.13 m/s with the track pitch of the lead-out region being 1.25 μm.

After this, a long playing CD-R according to a preferred embodiment of the present invention was manufactured by the same process as in example 1. Data was recorded on this long playing CD-R by a 1-12 fold speed CD-R writer (Plextor Co.), and assessment of recording and playback was performed by a CD-R standard inspection device (CD-CATS. Audio Development Co.). The result was that the lead-in region start radius was within specification and within the tolerance range.

Moreover, although this CD-R had a time 11 minutes longer time than the prior art limiting time of 23 minutes, that is, the CD-R can record 34 minutes (298 MB) of long playing high capacity record data, jitter was low, for example, 18 ns for both land jitter and pit jitter. Moreover, pit deviation and land deviation were both within specification, and in addition, I3 and I11 were both within specification. Reflectivity was 72%, which was within specification. Furthermore, a low BLER was obtained, the push-pull signal experienced no problems, and tracking was good. These properties were maintained from 1-fold speed to 12-fold speed writing. Furthermore, there were no faults in 16-fold speed writing or 20-fold writing by a Pulse Deck DDU1000. It was confirmed that the properties were maintained in this example.

Furthermore, in a playback device with a three-spot tracking method, tracking was insufficient. However, in a playback device with one beam, tracking was accurately performed. Because the start position of the program region or the lead-in region was displaced from the standard, utilization of a number of kinds of machines was impossible. However, it was possible to use the CD-R in a large number of playback machines. This is considered to be because of a displacement of the start position of the program region or the lead-in region with respect to the standard. However, the difference was not great.

Furthermore, the optimum laser power when reading was 6.5 mW and the groove bottom width was 390 nm.

### EXAMPLE 11

An optical disk according to a preferred embodiment of the present invention was manufactured in this example. The size of the optical disk was 80 mm. The groove start and ATIP start radius was 21 mm, the groove end ATIP end position was 39.2 mm, the lead-in region start time was 97:18:15, the program region start time was 00:00:00, the lead-out region start time was 34:02:00, the linear speed (single speed) was 1.11 m/s with the track pitch from the groove start position to the lead-in start position being 1.52 μm, the linear speed (single speed) was 1.11 m/s with the track pitch of the lead-in region being 1.52 μm, the linear speed (single speed) was 1.11 m/s with the track pitch of the program region being 1.24 μm, and the linear speed (single speed) was 0.9 m/s with the track pitch of the lead-out region being 1.2 μm.

After this, a long playing CD-R according to a preferred embodiment of the present invention was manufactured by the same process as in example 1. Data was recorded on this long playing CD-R by a 1-12 fold speed CD-R writer (Plextor Co.), and assessment of recording and playback was performed by a CD-R standard inspection device (CD-CATS, Audio Development Co.). The result was that the lead-in region start radius was within specification and no problems occurred. The program region start radius was also within specification and no problems occurred.

Moreover, although this CD-R had a time 11 minutes longer than the prior art limiting time of 23 minutes, that is, the CD-R can record 34 minutes (298 MB) of long playing high capacity record data, jitter was low, for example, 18 ns for both land jitter and pit jitter. Moreover, pit deviation and land deviation were both within specification, and in addition, I3 and I11 were both within specification. Reflectivity was 72%, which was within specification.

Furthermore, a low BLER was obtained, no problems were detected with the push-pull signal, and tracking was good. These properties were maintained from 1-fold speed to 12-fold speed writing. Furthermore, there were no faults in 16-fold speed writing or 20-fold speed writing by a Pulse Deck DDU1000. It was confirmed that the properties were also maintained. Furthermore, the optimum laser power when reading was 6.5 mW and the groove bottom width was 390 nm.

### EXAMPLE 12

An optical disk according to a preferred embodiment of the present invention was manufactured in this example. The size of the optical disk was 80 mm. The groove start and ATIP start radius was 21 mm, the groove end ATIP end position was 39.25 mm, the lead-in region start time was 97:18:15, the program region start time was 00:00:00, the lead-out region start time was 34:02:00, the linear speed (single speed) 1.11 m/s with the track pitch from the groove start position to the lead-in start position being 1.48 μm, the linear speed (single speed) was 1.11 m/s with the track pitch of the lead-in region being 1.48 μm, the linear speed (single speed) 1.11 m/s with the track pitch of program region being 1.24 μm, and the linear speed (single speed) was 1.11 m/s with the track pitch of the lead-out region being 1.2 μm.

After this, a long playing CD-R according to a preferred embodiment of the present invention was manufactured by the same process as in example 1. Data was recorded on this long playing CD-R by a 1-12 fold speed CD-R writer (Plextor Co.), and assessment of recording and playback was performed by a CD-R standard inspection device (CD-CATS, Audio Development Co.). The result was that the lead-in region start radius was within specification without any problems, and the program region start radius was within specification without any problems.

Moreover, although this CD-R had a time 11 minutes longer than the prior art limiting time of 23 minutes, that is, The CD-R can record 34 minutes (298 MB) of long playing high capacity record data, jitter was low, for example, 18 ns for both land jitter and pit jitter. Moreover, pit deviation and land deviation were both within specification, and in addition, I3 and I11 were both within specification. Reflectivity was 72%, also within specification. Furthermore, a low BLER was obtained, without any problems with the push-pull signal, and tracking was good. These properties were maintained from 1-fold speed to 12-fold speed writing. Furthermore, there were no faults in 16-fold speed writing or 20-fold speed writing by a Pulse Deck DDU1000, It was confirmed that the properties were maintained and the optimum laser power when reading was 5.9 mW. Furthermore, the groove bottom width was 390 nm.

### EXAMPLE 13

An optical disk according to a preferred embodiment of the present invention was manufactured in this example. The size of the optical disk was 80 mm. The groove start and ATIP start radius was 21 mm, the groove end ATIP end position was 39.41 mm, the lead-in region start time was 97:18:15, the program region start time was 00:00:00, the lead-out region start time was 40:02:00, the linear speed (single speed) was 1 m/s with the track pitch from the groove start position to the lead-in start position being 1.3 μm, the linear speed (single speed) was 1 m/s with the track pitch of the lead-in region being 1.3 μm, the linear speed (single speed) was 1 m/s with the track pitch of the program region being 1.22 μm, and the linear speed (single speed) was 1 m/s with the track pitch of the lead-out region being 1.2 μm.

After this, a long playing CD-R according to a preferred embodiment of the present invention was manufactured by the same process as in example 1. Data was recorded on this long playing CD-R by a 1-12 fold speed CD-R writer (Plextor Co.), and assessment of recording and playback was performed by a CD-R standard inspection device (CD-CATS, Audio Development Co.). The result was that the lead-in region start radius was within specification, without any problems, and the program region start radius was within specification, without any problems.

Moreover, although this CD-R had a time 17 minutes longer than the prior art limiting time of 23 minutes, that is, the CD-R can record 40 minutes (350 MB) of long playing high capacity record data, jitter was low, for example, 18 ns for both land jitter and pit jitter. Moreover, pit deviation and land deviation were both within specification, and in addition, I3 and I11 were both within specification. Reflectivity was 72%, also within specification. Furthermore, a low BLER was obtained, without any problems with the push-pull signal, and tracking was good. These properties were maintained from 1-fold speed to 12-fold speed writing. Furthermore, there were no faults in 16-fold speed writing or 20-fold speed writing by a Pulse Deck DDU1000. It was confirmed that the properties were maintained and the optimum laser power when reading was 5.4 mW. Furthermore, the groove bottom width was 390 nm.

### EXAMPLE 14

An optical disk according to a preferred embodiment of the present invention was manufactured in this example. Initially, a precision washed glass original disk having a diameter of 200 mm and a thickness of 6 mm was prepared. After primer had been coated on its surface, a positive type photoresist (S1818, Shipurei Co.) was spin coated and prebaked for 10 minutes on a hotplate at 100° C. A coated original disk having a coating of 180 nm was completed by this process.

Next, wobbled grooves were formed by a laser cutting machine in the coated original disk. This process is the most important point in the preferred embodiment of the present invention. Then according to the format for a CD-R given in the Orange Book, Standard 2, Version 3.1, the lead-in start time was 97:00:00, the lead-out start time (last possible start time of lead-out area) was 30:10:00, and the CD-R was disposed in a mastering generator Da3080 made by Kenwood Co.

The exposure start position was at a radius of 22.0 mm, in a region from a radius of 22.0 mm to 25.0 mm, the track pitch was set at 1.60 μm linear speed was 1.20 m/s, between radius of 25.00 and 25.10 mm, from the track pitch of only 1.60 μm, laser cutting in a proportion of 0.004 μm per 1 μm in the radial direction was carried out, while reducing per fixed amount, set such that at the time point of radius 25.10 mm, the track pitch becomes 1.20 μm.

The laser cutting ended when the radius of 39.10 mm was reached.

Then, using an inorganic alkali developing solution (Developer, Shipurei Co), diluted with ultra-pure water at a concentration of 20%, the developed master original disk was completed. Next, a treatment was performed to obtain electrical conductivity, by a nickel electroplating device made by Technotron Co., peeling from the glass original disk, and dieing-out at an internal diameter of 34.0 mm, and an external diameter of 138.00 mm, a nickel stamper was completed.

Setting this stamper in an injection molding device (SD40 alpha, made by Sumitomo Heavy Machine Industry) and performing injection molding, preparing a polycarbonate substrate, long playing CD-R according to the present invention were manufactured on a CD-R production line (Shingyuras Co.) using the stamper according to the present invention. Dye (Super Green, Ciba Co.) was spin coated and a reflective film and a lacquer were coated thereon, completing a blank CD-R disk.

When this blank disk was recorded on by a Sanyo Electric Machine Co. CD-R drive under 12-fold speed recording conditions, a total of 30 minutes and 10 seconds of recording is possible without any errors.

Moreover when the SLD (start lead-in diameter) and SPD (start program diameter) were measured on a CD-R standard inspection device (CD-CATS, Audio Development Co.), the SLD equaled 45.92 mm and the SPD equaled 49.5 mm, thereby satisfying the Orange Book standard. A CD-R disk, satisfying the Orange Book Standards, making a long playing sound recording possible, could be prepared in this manner.

### EXAMPLE 15

A CD-R according to a preferred embodiment of the present invention was manufactured by a method similar to example 14. The lead-in start time was 97:00:00, the lead-out start time (last possible start time of lead-out area) was 30:10:00, and the CD-R was disposed in a mastering generator Da3080 made by Kenwood Co.

With an exposure start position at a radius of 22.0 mm, setting the track pitch of the region from radius 22.0 mm to 24.95 mm to 1.60 μm and the linear speed to 1.20 m/s, between radius 24.95-25.00 mm, from only the track pitch of 1.60 μm, laser cutting, set in a proportion of 0.004 μm per 1 μm in the radial direction, was carried out, while reducing per fixed amount, such that at the time point of radius 25.00 mm, the track pitch becomes 1.20 μm.

Namely, in this embodiment, the track pitch of the end of the lead-in region gradually changes in the abovementioned proportion. Then, laser cutting ends on reaching the radius of 39.10 mm.

When this blank disk was recorded on by a Sanyo Electric Co. CD-R drive under 12-fold speed recording conditions, a total of 30 minutes and 10 seconds of recording is possible without any errors.

Moreover, when the SLD (start lead-in diameter) and SPD (start program diameter) were measured on a CD-R standard inspection device (CD-CATS, Audio Development Co.), the SLD equaled 45.92 mm and the SPD equaled 49.0 mm, which satisfies the Orange Book standard.

A CD-R disk having a long playing sound recording time could be prepared in this manner to satisfy the Orange Book standards.

### EXAMPLE 16

A CD-R according to a preferred embodiment of the present invention was manufactured by a method similar to example 14. The lead-in start time was 97:00:00, the lead-out start time (last possible start time of lead-out area) was 30:10:00, and the CD-R was disposed in a mastering generator Da3080 made by Kenwood Co.

With an exposure start position at a radius of 22.0 mm, setting the track pitch of the region from radius 22.0 mm to 25.00 mm at 1.60 μm and the linear speed at 1.20 m/s, between radius 24.95-25.00 mm, from only a linear speed of 1.20 m/s, laser cutting, set such that at the time point of radius 25.00 mm the linear speed becomes 1.00 m/s, was performed. Namely, the track pitch is maintained as it is at the end of the lead-in region, and laser cutting ends at the time point when the radius reaches 39.10 mm.

When this blank disk was recorded by a Sanyo Electric Machine Co. CD-R drive under 12-fold speed recording conditions, a total of 30 minutes and 10 seconds of recording is possible without any errors.

Moreover when the SLD and SPD were measured on a CD-R standard inspection device (CD-CATS, Audio Development Co.), the SLD equaled 45.92 mm and the SPD equaled 49.0 mm, which satisfies the Orange Book standard. A CD-R disk having a long playing sound recording time possible could be prepared in this manner satisfies the Orange Book standards.

### EXAMPLE 17

A CD-R according to a preferred embodiment of the present invention was manufactured by a method similar to example 14. The size of the optical disk was 80 mm. The groove start and ATIP start radius was 21 mm, the groove end and ATIP end position was 39 mm, the lead-in region start time was 97:27:00, the program region start time was 00:00:00, the lead-out region start time (last possible start time of lead-out area) was 40:10:00, the linear speed was 1.2 m/s with the track pitch from the groove start position to the lead-in start position being 1.52 μm, the linear speed was 1.2 m/s with the track pitch of the lead-in region being 1.52 μm, the linear speed was 0.95 m/s with the track pitch of the program region being 1.10 μm, and the linear speed was 0.95 m/s with the track pitch of the lead-out region being 1.10 μm.

From a position of radius 24.5 mm within the lead-in region, the track pitch and linear speed were changed in a fixed proportion, so as to become the same as the track pitch and linear speed of the program region at the end point of the lead-in region. Data was recorded on this long playing CD-R by a 1-12 fold speed CD-R writer (Plextor Co.), and assessment of recording and playback was performed by a CD-R standard inspection device (CD-CATS, Audio Development Co.). This CD-R had a time 17 minutes longer than the prior art limiting time of 23 minutes, that is, the CR-R can record 40 minutes (350 MB) of long playing high capacity record data. However, marks formed in the program region were detected, but jitter and the like properties were more or less poor. These properties were maintained from 1-fold speed to 12-fold speed writing. Nevertheless, in the case of 16-fold speed writing and of 20-fold speed writing by a Pulse Deck DDU1000, it was found that errors arose during reading in about 5% of the whole disk.

### EXAMPLE 18

A CD-R according to a preferred embodiment of the present invention was manufactured by a method similar to example 14. The size of the optical disk was 80 mm. The groove start and ATIP start radius was 21 mm, the groove end and ATIP end position was 39.1 mm, the lead-in region start time was 97:27:00, the program region start time was 00:00:00, the lead-out region start time was 34:02:00, the linear speed was 1.11 m/s with the track pitch from the groove start position to the lead-in start position being 1.50 μm, the linear speed was 1.11 m/s with the track pitch of the lead-in region being 1.50 μm, the linear speed was 1.11 m/s with the track pitch of the program region being 1.23 μm, and the linear speed was 1.11 m/s with the track pitch of the lead-out region being 1.23 μm.

From a position of radius 24.5 mm within the lead-in region, the track pitch was changed in a fixed proportion, so as to become the same as the track pitch of the program region at the end point of the lead-in region.

Data was recorded on this long playing CD-R by a 1-12 fold speed CD-R writer (Plextor Co.), and assessment of recording and playback was performed by a CD-R standard inspection device (CD-CATS, Audio Development Co.). The results were that the lead-in start radius was 22.97 mm, without any problems and within specification and the program region start radius was 24.81 mm, without any problems and within specification.

Moreover, this CD-R had a time 11 minutes longer than the prior art limiting time of 23 minutes, that is, the CD-R can record 34 minutes (298 MB) of long playing high capacity record data. Nevertheless, jitter was low, for example, 20 ns for both land jitter and pit jitter. Moreover, pit deviation and land deviation were both within specification and, in addition, I3 and I11 were both within specification. Reflectivity was 71%, also within specification.

Furthermore, a low BLER was obtained, as well as a push-pull signal without any problems, and tracking was good. These properties were maintained from 1-fold speed to 12-fold speed writing. Furthermore, there were no faults in 16-fold speed writing or 20-speed writing by a Pulse Deck DDU1000, and it was confirmed that the properties were maintained.

### EXAMPLE 19

A CD-R according to a preferred embodiment of the present invention was manufactured by a method similar to example 14. The size of the optical disk was 80 mm. The groove start and ATIP start radius was 21 mm, the groove end and ATIP end position was 39.1 mm, the lead-in region start time was 97:27:00, the program region start time was 00:00:00, the lead-out region start time was 34:07:00, the linear speed was 1.16 m/s with the track pitch from the groove start position to the lead-in start position being 1.50 μm, the linear speed was 1.16 m/s with the track pitch of the lead-in region being 1.50 μm, the linear speed was 1.16 m/s with the track pitch of the program region being 1.18 μm, and the linear speed was 1.16 m/s with the track pitch of the lead-out region being 1.18 μm.

From a position of radius 24.6 mm within the lead-in region, the track pitch was changed in a fixed proportion, so as to become the same as the track pitch of the program region at the end point of the lead-in region.

Data was recorded on this long playing CD-R by a 1-12 fold speed CD-R writer (Plextor Co.), and assessment of recording and playback was performed by a CD-R standard inspection device (CD-CATS, Audio Development Co.). The results were that the lead-in start radius was 22.99 mm, without any problems and within specification and the program region start radius was 24.84 mm, without any problems and within specification.

Moreover, this CD-R had a time 11 minutes longer than the prior art limiting time of 23 minutes, that is, the CD-R can record 34 minutes (298 MB) of long playing high capacity record data. Nevertheless, jitter was low, for example, 18 ns for both land jitter and pit jitter. Moreover, pit deviation and land deviation were both within specification and, in addition, I3 and I11 were both within specification. Reflectivity was 72%, also within specification. Furthermore, a low BLER was obtained, as well as a push-pull signal without any problems, and tracking was good.

These properties were maintained from 1-fold speed to 12-fold speed writing. Furthermore, there were no faults in 16-fold speed writing or 20-fold speed writing by a Pulse Deck DDU1000, and it was confirmed that the properties were maintained. Nevertheless, the productivity of the plastic substrate was inferior in comparison with that of example 1.

Although preferred embodiments of the present invention have been shown and described, it will be appreciated by those skilled in the art that changes may be made in these embodiments without departing from the principle and spirit of the invention, the scope of which is defined in the appended claims and their equivalents.

What is claimed is:

1. A disk-shaped optical recording medium having, in sequence from an inner circumference side to an outer circumference side, a PCA region, a PMA region, a lead-in region, a program region and a lead-out region, comprising:
a meandering groove or land upon which a light beam is tracked, thereby performing recording and playback of data with the disk-shaped optical recording medium, wherein a track pitch of the program region is narrower than a track pitch of each of the PCA region, PMA region and lead-in region.

2. The disk-shaped optical recording medium according to claim 1, wherein a track pitch of the lead-out region is narrower than the track pitch of the program region.

3. The disk-shaped optical recording medium according to claim 1, further comprising a track pitch transition region in which a track pitch changes gradually.

4. The disk-shaped optical recording medium according to claim 3, wherein
the track pitch of the program region gradually changes in a terminal portion of the lead-in region, and
the change of track pitch ends within the lead-in region.

5. The disk-shaped optical recording medium according to claim 1, wherein a linear speed of the PCA region and a linear speed of the program region are the same.

6. A disk-shaped optical recording medium having, in sequence from an inner circumference side to an outer circumference side, a PCA region, a PMA region, a lead-in region, a program region and a lead-out region, comprising:
a meandering groove or land upon which a light beam is tracked, thereby performing recording and playback of data with the disk-shaped optical recording medium, wherein a linear speed of the program region is slower than a linear speed of each of the PCA region, PMA region and lead-in region.

7. The disk-shaped optical recording medium according to claim 6, wherein a linear speed of the lead-out region is slower than the linear speed of the program region.

8. The disk-shaped optical recording medium according to claim 6, further comprising a linear speed transition region in which a linear speed changes gradually.

9. The disk-shaped optical recording medium according to claim 8, wherein the linear speed of the program region is made slower than the linear speed of each of the PCA region, PMA region, and lead-in region, the linear speed gradually changes at a terminal portion of the lead-in region, and the change of linear speed ends within the lead-in region.

10. The disk-shaped optical recording medium according to claim 1, wherein the track pitch of the program region is between 1.2 μm and 1.3 μm.

11. The disk-shaped optical recording medium according to claim 10, wherein a width of the meandering groove or land of the program region, in which data is recorded, is between 300 nm and 550 nm.

12. The disk-shaped optical recording medium according to claim 10, wherein a laser power used on the optical recording medium is between 4.9 mW and 6.5 mW.

13. The disk-shaped optical recording medium according to claim 10, wherein an eccentricity amount of the respective grooves or lands of the optical recording medium is 30 μm or less.

14. The disk-shaped optical recording medium according to claim 1, wherein the linear speed of the program region is made 1.0 m/s or more.

15. The disk-shaped optical recording medium according to claim 2, wherein the linear speed of the program region is made 1.0 m/s or more.

16. The disk-shaped optical recording medium according to claim 1, wherein a width of the groove or land used for recording data is narrower than a width of the groove or land where data is not recorded.

17. The disk-shaped optical recording medium according to claim 2, wherein a width of the groove or land used for recording data is narrower than a width of the groove or land where data is not recorded.

18. The disk-shaped optical recording medium according to claim 6, wherein a width of the groove or land used for recording data is narrower than a width of the groove or land where data is not recorded.

19. The disk-shaped optical recording medium according to claim 1, wherein a diameter of the optical recording medium is 80 mm and the optical recording medium has a recording time of between 30 and 34 minutes.

20. The disk-shaped optical recording medium according to claim 6, wherein a diameter of the optical recording medium is 80 mm and the optical recording medium has a recording time of between 30 and 40 minutes.

21. A stamper comprising convex portions corresponding to concave portions of the optical recording medium of claim 1 and concave portions corresponding to convex portions of the optical recording medium of claim 1.

22. A stamper comprising convex portions corresponding to concave portions of the optical recording medium of claim 6 and concave portions corresponding to convex portions of the optical recording medium of claim 6.

23. The stamper according to claim 21, wherein an eccentricity amount of the concave portions or convex portions formed in the stamper is 10 μm or less.

24. The stamper according to claim 22, wherein an eccentricity amount of the concave portions or convex portions formed in the stamper is 10 μm or less.

25. A method of manufacturing the stamper of claim 21, comprising:
using a first molding die made of metal to mold a second molding die made of resin; and
molding the stamper made of metal which is a third molding die from the second molding die.

26. A method of manufacturing the stamper of claim 22, comprising;
using a first molding die made of metal to mold a second molding die made of resin; and
molding the stamper made of metal which is a third molding die from the second molding die.

27. A disk-shaped optical recording medium, comprising:
at least a program region; and
a meandering groove or land upon which a light beam is tracked, thereby performing recording and playback of data with the disk-shaped optical recording medium, wherein a track pitch is between 1.2 μm and 1.3 μm and a linear speed of the program region is between 1.0 m/s and 1.13 m/s.

28. The disk-shaped optical recording medium according to claim 27, wherein a width of the groove or land of the program region recorded with the data is between 300 nm and 550 nm.

29. The disk-shaped optical recording medium according to claim 28, wherein a laser power at recording time is between 4.9 mW and 6.5 mW.

30. A disk-shaped optical information medium, comprising:
at least a lead-in region having tracks, memorized contents information of the disk-shaped optical information medium;
a program region having tracks, memorized information recorded in the disk-shaped optical information medium; and
a lead-out region having tracks, denoting an end of tracks in the disk-shaped optical information medium, wherein a track pitch of the lead-out region is smaller than a track pitch of any other regions.

31. The disk-shaped optical information medium according to claim 30, further comprising a track pitch transition region in which a track pitch changes gradually.

32. The disk-shaped optical information medium according to claim 30, wherein a linear speed of the lead-in region and a linear speed of the program region are the same.

33. The disk-shaped optical information medium according to claim 30, wherein a track pitch of the program region is between 1.2 μm and 1.3 μm.

34. The disk-shaped optical information medium according to claim 33, wherein a linear speed of the program region is 1.0 m/s or more.

35. A stamper comprising convex portions corresponding to concave portions of the optical information medium of claim 30 and concave portions corresponding to convex portions of the optical information medium of claim 30.

36. The stamper according to claim 35, wherein an eccentricity amount of the concave portions or convex portions formed in the stamper is 10 μm or less.

37. A disk-shaped optical information medium, comprising:
at least a lead-in region having tracks, memorized contents information of the disk-shaped optical information medium;
a program region having tracks, memorized information recorded in the disk-shaped optical information medium; and
a lead-out region having tracks, denoting an end of tracks in the disk-shaped optical information medium, wherein a linear speed of lead-out region is smaller than a linear speed of any other regions.

38. The disk-shaped optical information medium according to claim 37, further comprising a linear speed transition region in which a linear speed changes gradually.

39. The disk-shaped optical information medium according to claim 37, wherein a track pitch of the program region is between 1.2 μm and 1.3 μm.

40. The disk-shaped optical information medium according to claim 39, wherein a linear speed of the program region is 1.0 m/s or more.

41. A stamper comprising convex portions corresponding to concave portions of the optical information medium of claim 37 and concave portions corresponding to convex portions of the optical information medium of claim 37.

42. The disk-shaped optical recording medium according to claim 27, wherein a diameter of the optical recording medium is 80 mm and the optical recording medium has a recording time of between 30 and 40 minutes.

43. A disk-shaped optical recording medium having, in sequence from an inner circumference side to an outer circumference side, a PCA region, a PMA region, a lead-in region, a program region and a lead-out region, comprising:
a meandering groove or land upon which a light beam is tracked, thereby performing recording and a playback of data with the disk-shaped optical recording medium, wherein at least a track pitch or a linear speed of either the PCA region or the PMA region is greater than a track pitch or linear speed of the other regions.

44. The disk-shaped optical recording medium according to claim 43, wherein at least the track pitch or the linear speed of the PCA region is greater than the track pitch or the linear speed of the other regions.

45. The disk-shaped optical recording medium according to claim 43, wherein at least the track pitch or the linear speed of the PMA region is greater than the track pitch or the linear speed of the other regions.

46. The disk-shaped optical recording medium according to claim 43, wherein at least the track pitch or the linear speed of the PCA region and the PMA region are greater than the track pitch or linear speed of any other regions.
